(19) United States
(12) Patent Application Publication
(10) Pub. No.: US 2007/0263244 A1
(43) Pub. Date: Nov. 15, 2007

(54) Image Forming Device, Printer Complex System and Medium Conveying Device for the Device, Information Processing Unit for Supplying Image Data to the Image Forming Device, and Image Forming System and Image Forming Method Provided with These

(75) Inventors: Hiroshi Sugitani, Ibaraki (JP); Akira Katayama, Ibaraki (JP); Kenji Hatakeyama, Ibaraki (JP); Toshio Ikeda, Tokyo (JP); Akio Aoki, Ibaraki (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Mitsukaido-shi (JP)

(21) Appl. No.: 10/558,565

(22) PCT Filed: Jun. 1, 2004
(86) PCT No.: PCT/JP04/07912

§ 371 Date: Mar. 14, 2007

(30) Foreign Application Priority Data
Jun. 2, 2003 (JP) 2003-156675

(51) Int. Cl. H04N 1/00

(52) U.S. Cl. 358/1.15

(57) ABSTRACT

To meet a demand for changing a print medium size, particularly for increasing the size of print medium while at the same time satisfying the demand for higher printing speed. To that end, a plurality of printer units (116), which are spatially independent of each other (separate from each other) and also independent in the signal system and the ink system, are arranged in an appropriate layout to allow for a line-sequential printing. An information processing device (100) divides a generated image into a plurality of pieces of print data and transfers them to the plurality of printer units. A transport device (117) is installed to feed a large-sized print medium to an area where the plurality of printer units are arranged. The transport device transfers to each of the plurality of printer units a print timing signal corresponding to the position of each printer unit.

### TECHNICAL FIELD

The present invention relates to an image forming apparatus, a printer complex system and a medium transport device for the image forming apparatus, an information processing device for supplying image data to the image forming apparatus, and an image forming system equipped with these and an image forming method. In particular, the present invention can suitably be applied to an image formation on a relatively large-sized print medium, say, even 500 mm or more in width.

### BACKGROUND ART

Various kinds of apparatus and methods are available for printing on a print medium. An ink jet printing system, among others, forms an image by ejecting ink from a print head as a printing means onto a print medium, and has many advantages including an ease with which the print head can be reduced in size, an ability to form an image with high resolution at high speed, low running cost achieved by the ability to print on so-called plain paper, low noise because of a non-impact printing system employed, and an ease with which to adopt a construction for forming color images using multiple color inks.

Owing to these advantages, the ink jet printing system has found a wide range of applications for industrial, office and personal (individual or home) use, and at the same time the purpose of printing is becoming diversified. Under these circumstances, a variety of kinds of print mediums has come to be used. In the industrial field in particular, the print medium size ranges widely, from a relatively small one such as labels attached to products and their packages to a relatively large one more than A2 size. The printing apparatus used in the industrial field also must meet far more stringent requirements than those for personal use in terms of high-speed printing and operation stability.

A serial type printer, as described in reference patent document 1, forms an image by moving a print head along a print medium as it ejects ink (main scan), feeding the print medium a predetermined distance each time one main scan is completed (subscan), performing the next main scan on the resting print medium, and repeating this sequence of operations. Unlike the serial type printer, a line type printer, which uses a print head having a large number of ink nozzles arrayed in a direction perpendicular to a print medium transport direction (subscan direction), is able to form an image at high speed. Because of this advantage, the line printer type ink jet printing apparatus is drawing attention as a printing apparatus suitable for industrial applications.

In the industrial field, however, various sizes of print mediums are used as described above, and at times it is required to print on print mediums of A2 size or more. In the case of a print head used in the line printer, processing the print head to form an extremely large number of nozzles without any defects over the entire width of a print area is difficult (ink ejection openings, liquid paths communicating with the openings, and devices or elements installed in the liquid paths to generate energy for ink ejection may generally be called nozzles unless otherwise specifically stated). Take for example a case in which printing is performed on an A2-size print medium over a print width of about 420 mm (shorter side of A2-size paper) at 600 dpi. This requires about 10,000 ejection openings in this print width. Forming such a large number of nozzles corresponding to these ejection openings without a defect is very difficult to achieve.

A conventional practice to deal with this requirement involves arranging a plurality of relatively inexpensive, short print head chips with high precision to form a long ink jet print head for line printer to meet the required length (e.g., reference patent document 2). Arranging an appropriate number of print head chips in this manner can deal with a variety of sizes of print medium.

In the information processing device, which serves as a host device to supply image data for printing to the printing apparatus, a mapping system of image data and a transfer system are so arranged as to conform with the construction of the printing apparatus, particularly the number of nozzles and the arrangement of nozzles and print head chips. The image data generated by the user is supplied to the printing apparatus through a communication interface (e.g., reference patent document 1).

Reference patent document 1: Japanese Patent Application Laid-open No. 2001-171140

Reference patent document 2: Japanese Patent Application Laid-open No. 60-137655 (1985)

### DISCLOSURE OF THE INVENTION

As described above, it is possible to achieve a higher speed printing by using the line printer type ink jet printer and to deal with a variety of sizes of print medium by arranging an appropriate number of short print head chips in line. In practice, however, dedicate printers are constructed to meet the user needs and it is therefore difficult to quickly design various line printers at low cost by flexibly complying with various needs of the user.

One of the reasons is that when it is attempted to increase the print width by arranging an appropriate number of print head chips in line, the hardware and software of the print head control system also needs to be modified according to the print head configuration. An ink jet printing apparatus is generally provided with a recovery system and with a drive mechanism that brings the ink jet print head close to or away from the recovery system. These recovery system and drive mechanism must also be designed to match the construction of the print head. In addition to the construction of the printing apparatus side, the host device or information processing device also requires significant specification changes in connection with the image data mapping and with the transfer system.

The present invention has been accomplished under these circumstances and it is an object of this invention to provide a capability to quickly and easily meet a demand for changing the print medium size, particularly a demand for increasing the print medium size, while at the same time satisfying a demand for faster printing.

Another object of this invention is to provide an image forming apparatus of a simple construction at low cost, a printer complex system and a medium transport device for the image forming apparatus, an information processing device to supply image data to the image forming apparatus, and an image forming system equipped with these.

To realize the above objectives, the image forming system according to this invention comprises:

a plurality of printer units separate from each other, each independently having a print head, the print head having print elements arrayed therein in a predetermined direction over a predetermined range, the plurality of printer units being arranged over a range substantially equal to a total of the predetermined ranges of the print heads of all the printer units;

a medium transport device to feed a print medium relative to the plurality of printer units; and

an information processing device to supply print data corresponding to a plurality of areas where the plurality of printer units are located.

The method of this invention for forming an image on a common print medium by using a plurality of separate printer units is characterized in that the plurality of printer units each independently have a print head, each of the print heads has print elements arrayed therein in a predetermined direction over a predetermined range, and the plurality of printer units are arranged over a range substantially equal to a total of the predetermined ranges of the print heads of all the printer units.

The information processing device of this invention comprises:

means for dividing an image to be printed into a plurality of areas;

means for converting image data corresponding to the divided areas into print data; and

means for transferring the generated print data corresponding to the respective areas to a plurality of printer units arranged to cooperate with each other to print the image.

The information processing method of this invention comprises:

a step of dividing an image to be printed into a plurality of areas;

a step of converting image data corresponding to the divided areas into print data; and

a step of transferring the generated print data corresponding to the respective areas to a plurality of printer units arranged to cooperate with each other to print the image.

This invention also provides a control program to cause a computer to execute the above information processing method and a storage medium storing this control program.

The image forming apparatus of this invention comprises:

a plurality of separate printer units, each independently having a print head, the print head having print elements arrayed therein in a predetermined direction over a predetermined range, the plurality of printer units being arranged over a range substantially equal to a total of the predetermined ranges of the print heads of all the printer units; and

a medium transport device to feed a print medium relative to the plurality of printer units.

The medium transport device of this invention for transporting a print medium relative to a plurality of printer units arranged to cooperate with each other to print an image, comprises:

means for detecting a position of the print medium being transported; and means for sending to each of the plurality of printer units an instruction signal for starting a printing operation according to the detection of the print medium transport position, the print start instruction signal conforming to the location of each printer unit.

The printer complex system of this invention comprises: a plurality of separate printer units, each independently having a print head, the print head having print elements arrayed therein in a predetermined direction over a predetermined range; and

a support member to arrange and support the plurality of printer units over a range substantially equal to a total of the predetermined ranges of the print heads of all the printer units.

The present invention also provides a printer unit used in the printer complex system described above, wherein the printer unit holds a print head having print elements arrayed therein in a predetermined direction over a predetermined range and can be mounted on the support member. This invention also provides a print head mountable on the printer unit described above.

Further, the present invention provides a printer unit using a print head having print elements arrayed therein over a predetermined range, comprising:

means for receiving print data from a host device; and

means for causing the print data to be printed in response to an instruction from print start instruction means;

wherein the printer unit can be mounted on or dismounted from a support member installed in a medium transport device.

This invention also provides a print head mountable on the printer unit described above.

With this invention, a plurality of printer units, which are spatially independent (separate) of each other or also independent in the signal system and ink system, are arranged in an appropriate layout and a medium transport system is used to feed a print medium to an area where these printer units are installed. And properly divided image data is supplied to each of the printer units to form an image. This arrangement makes it possible to quickly and easily cope with a demand for changing the print medium size, particularly a demand for size increase, while at the same time satisfying a demand for faster printing.

Further, the present invention can also provide a low-cost image forming apparatus of a simple construction, a printer complex system and a medium transport device for the image forming apparatus, an information processing device to supply image data to the image forming apparatus, and an image forming system incorporating these devices.

### BRIEF DESCRIPTION OF THE DRAWINGS

FIG. 1 is a block diagram showing an outline of an image forming system according to one embodiment of this invention;

FIG. 2 is a schematic perspective view showing an outline of the image forming system according to one embodiment of this invention;

FIG. 3A and FIG. 3B illustrate an example display screen for setting the number of printing apparatus (number of divisions) used in the image forming system of FIG. 1 and for setting a print area assignment for each printing apparatus, the setting in this screen being controlled by a printer driver running on an information processing device;

FIG. 4 illustrates an example display screen for setting a print area width for each printing apparatus which is controlled by the printer driver;

FIG. 5 is a flow chart showing an example operation sequence of the information processing device that is initiated when the printer driver requests an execution of printing;

FIG. 6A and FIG. 6B illustrate other operation flows of the information processing device in performing print data generation processing and print data transfer processing, the print data being transferred parallelly to a plurality of printing apparatus;

FIG. 7 illustrate an example printer driver screen showing division lines on an image which is generated by the information processing device based on the number of printing apparatus (division number) set by the setting screen of FIG. 3A;

FIG. 8 is a block diagram showing an example configuration of a control system in the printing apparatus according to one embodiment of this invention;

FIG. 9 is a block diagram showing an example configuration of a control system in the medium transport device according to one embodiment of this invention;

FIG. 10 is a schematic perspective view showing another configuration of the medium transport device for transporting a print medium;

FIG. 11 is a flow chart showing interrelated operation sequences of the information processing device in the image forming system, the printing apparatus in the printer complex system, and the medium transport device;

FIG. 12 is a block diagram showing an example configuration of a signal system for a plurality of printing apparatus making up the printer complex system;

FIG. 13 is a schematic diagram showing a configuration of an ink supply system of an ink system for a plurality of printing apparatus making up the printer complex system;

FIG. 14A to FIG. 14D are schematic diagrams showing outline configuration of print heads and a recovery mechanism installed in each of the printing apparatus and their relative operations;

FIG. 15 is a schematic diagram showing an arrangement of essential components of the ink system in one printing apparatus;

FIG. 16 is a schematic diagram showing an example inner configuration of the ink system for one print head;

FIG. 17A and FIG. 17B are schematic diagrams showing an ink path in the print head;

FIG. 18 is a diagram showing an operation of the ink system of FIG. 16;

FIG. 19 is a schematic diagram showing another configuration of the ink system for one print head;

FIG. 20 is a diagram showing an operation of the ink system of FIG. 19; and

FIG. 21 is a flow chart showing a control sequence of the ink system of FIG. 16.

### BEST MODE FOR CARRYING OUT THE INVENTION

Now, the present invention will be described in detail concerning the following items by referring to the accompanying drawings.

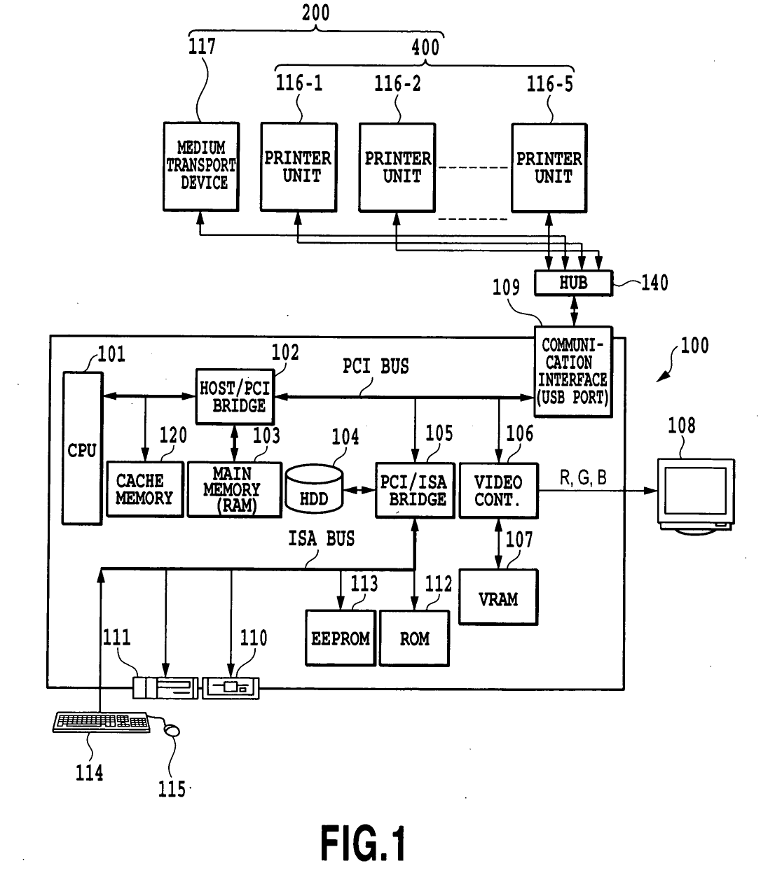

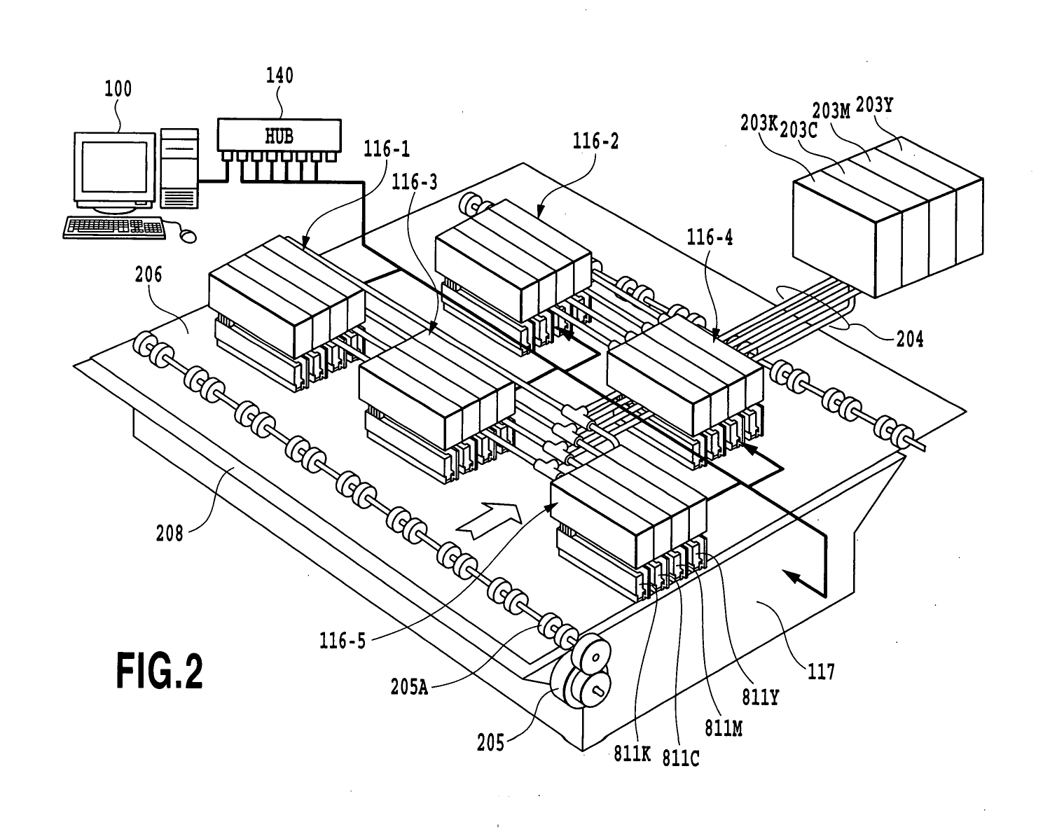

1. Outline of the image forming system (FIG. 1 and FIG. 2)

2. Information Processing Device (FIG. 1 to FIG. 7)

3. Image Forming Apparatus (FIG. 2 and FIG. 8 to FIG. 10)

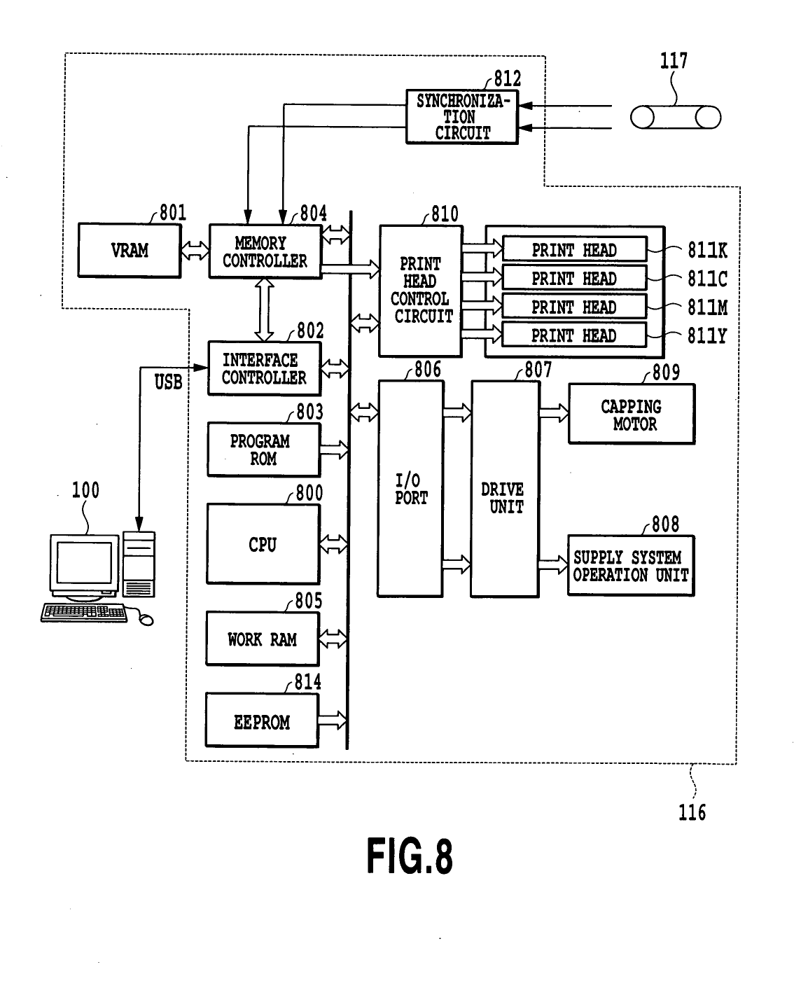

3-1. Composite Printer System (FIG. 2 and FIG. 8)

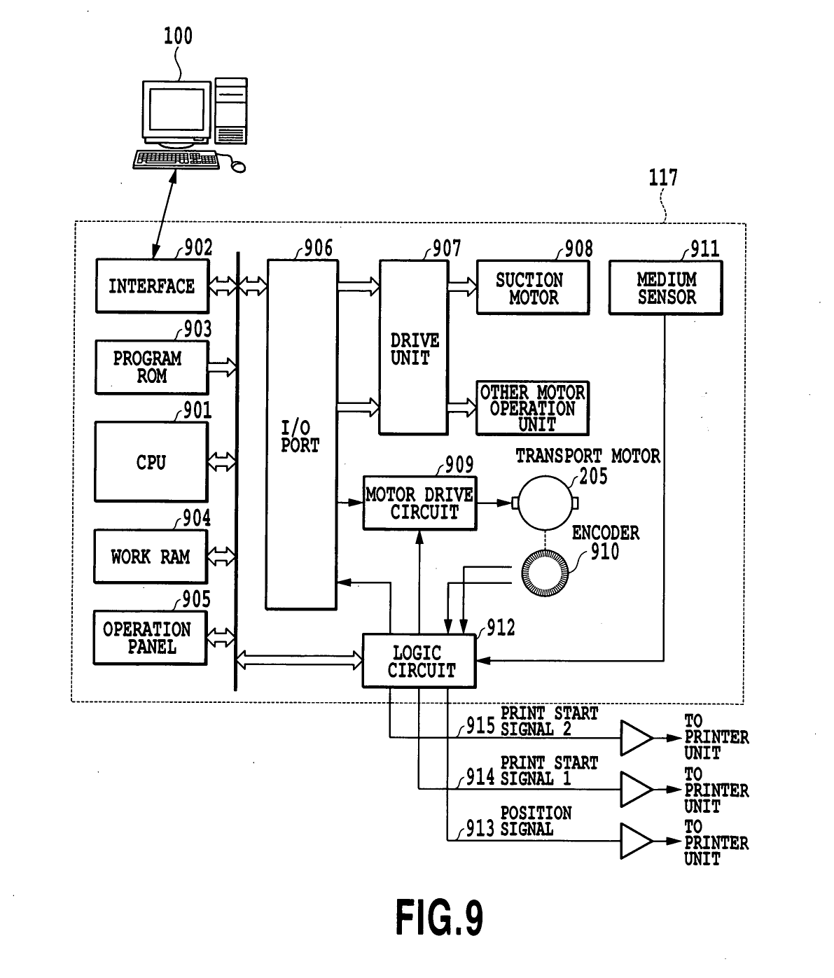

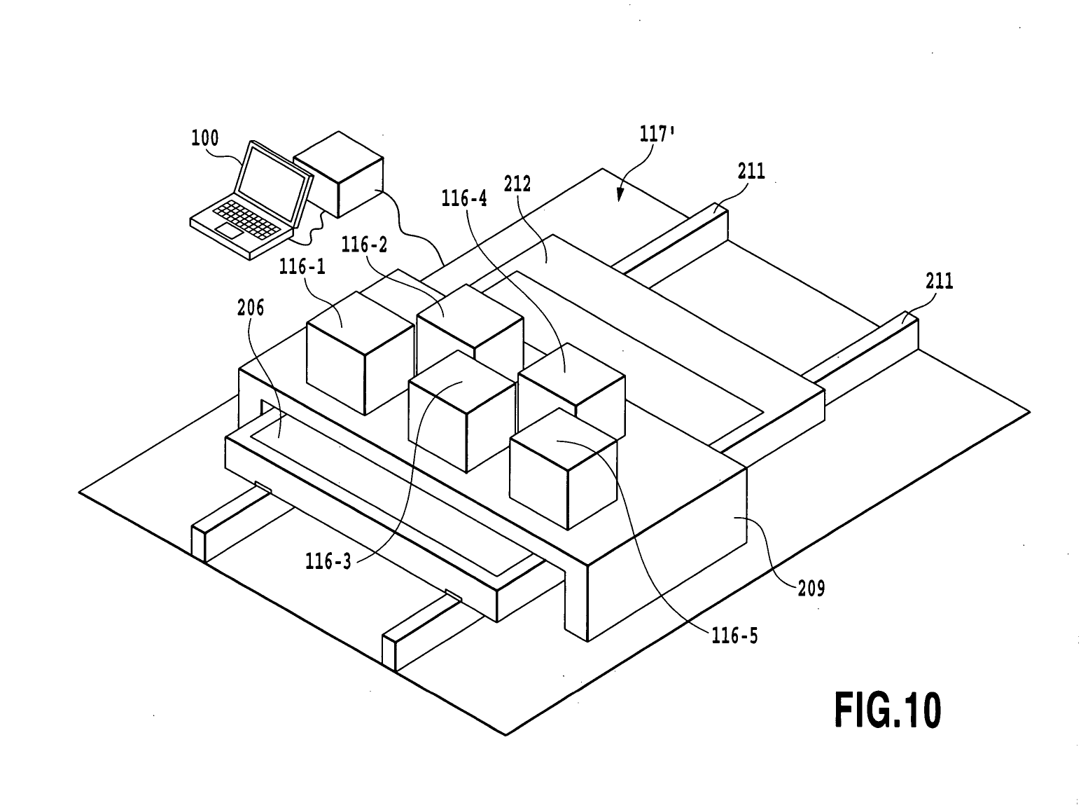

3-2. Medium Transport Device (FIG. 2, FIG. 9 and FIG. 10)

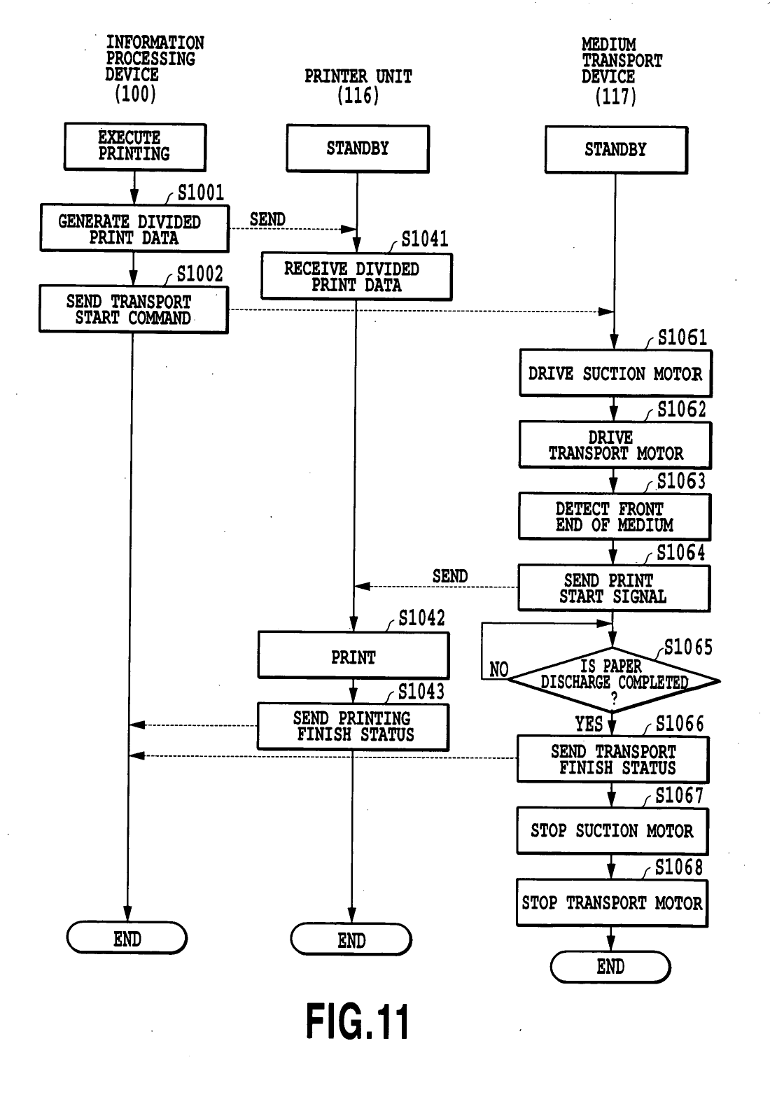

4. Outline of Operation of the Image Forming System (FIG. 11)

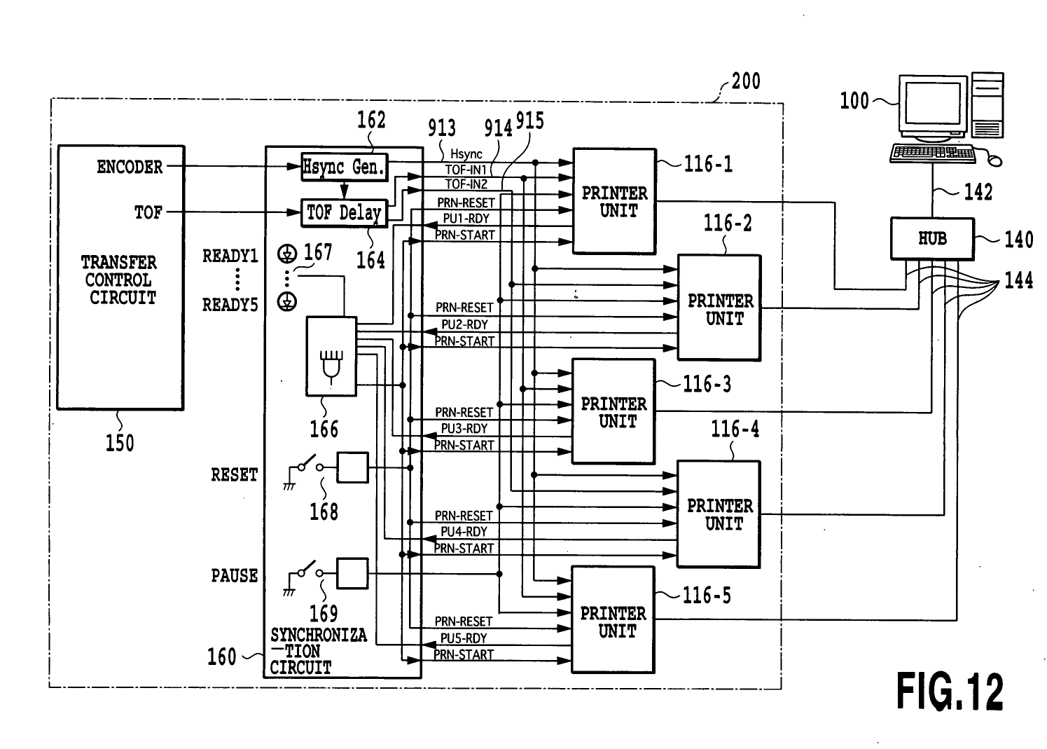

5. Signal System to the Printer Complex System (FIG. 12)

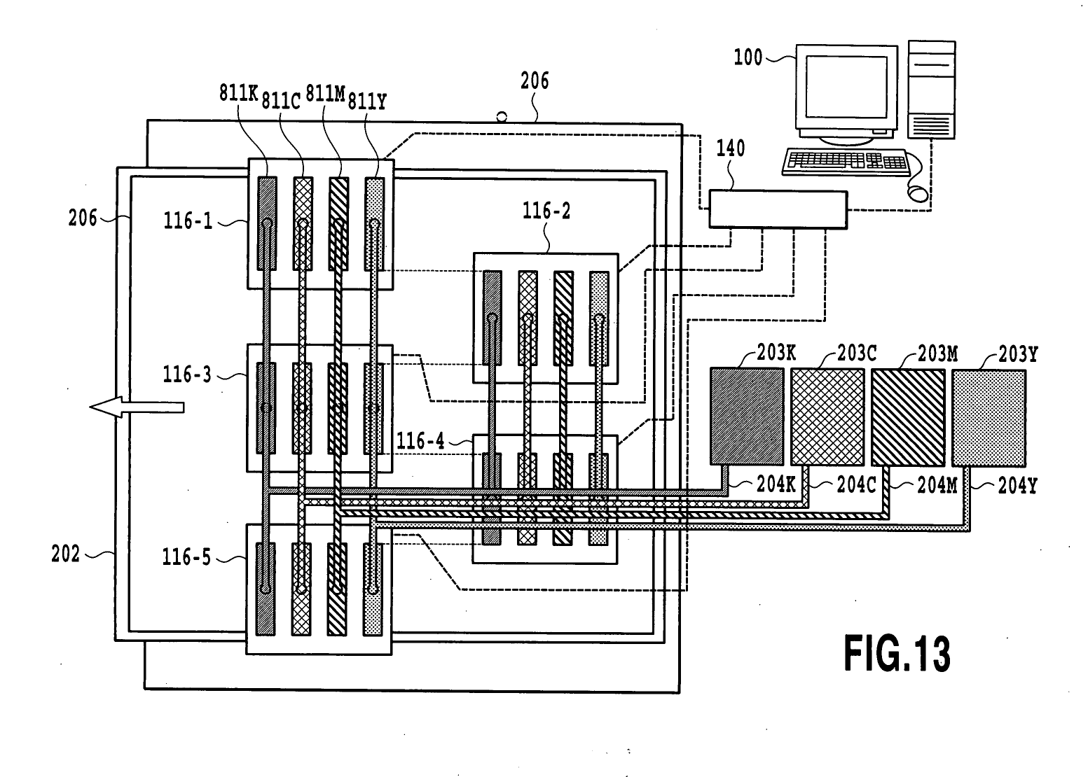

6. Ink System for the Printer Complex System or Printer Unit (FIG. 13 to FIG. 21)

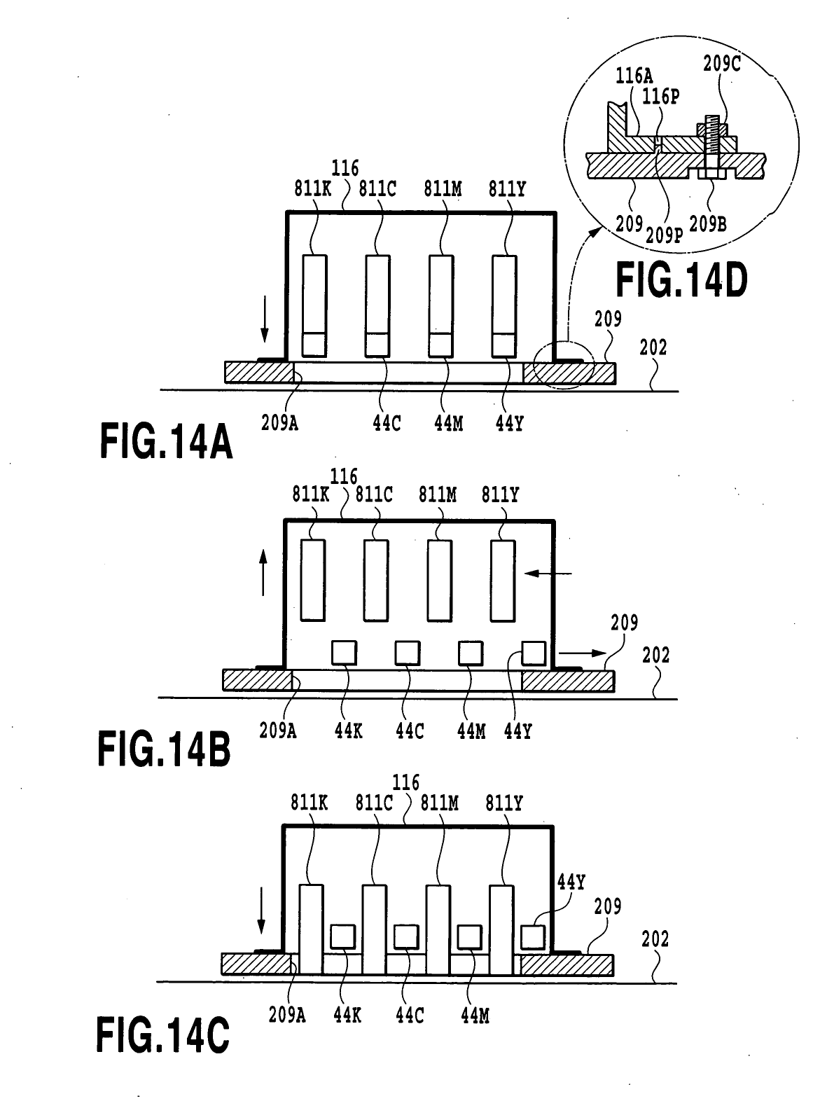

6-1. Basic Configuration of the Ink System (FIG. 13 and FIG. 14A to FIG. 14C)

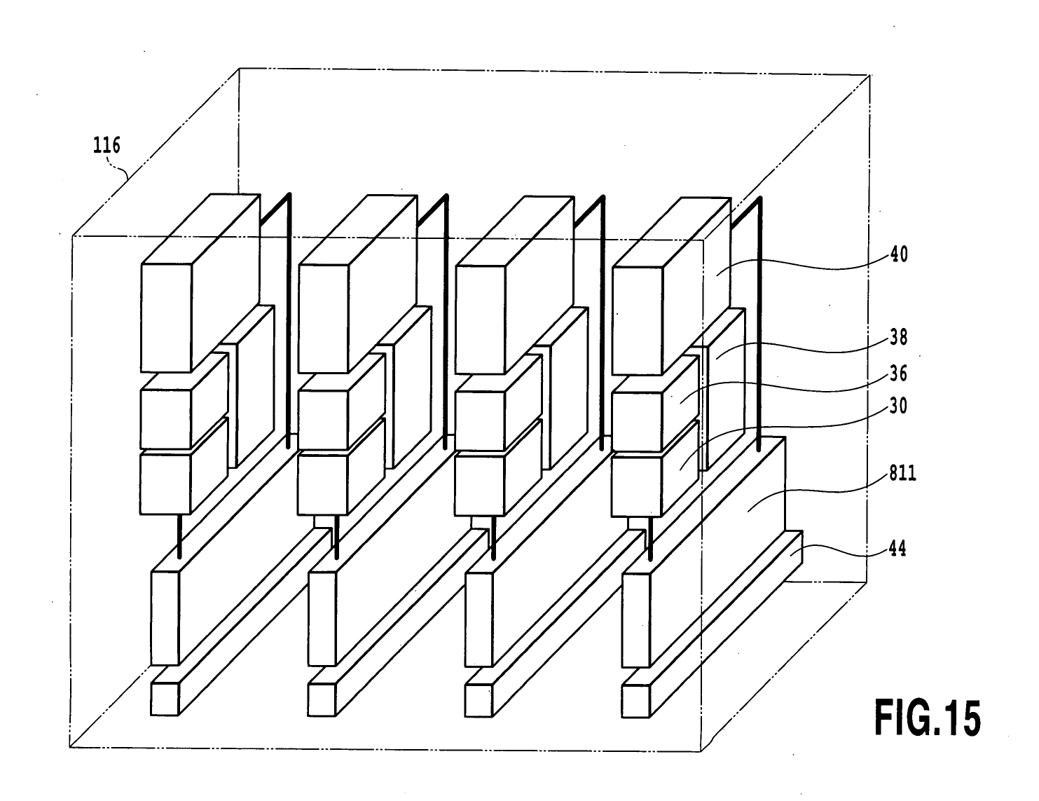

6-2. First Example (FIG. 15 to FIG. 18)

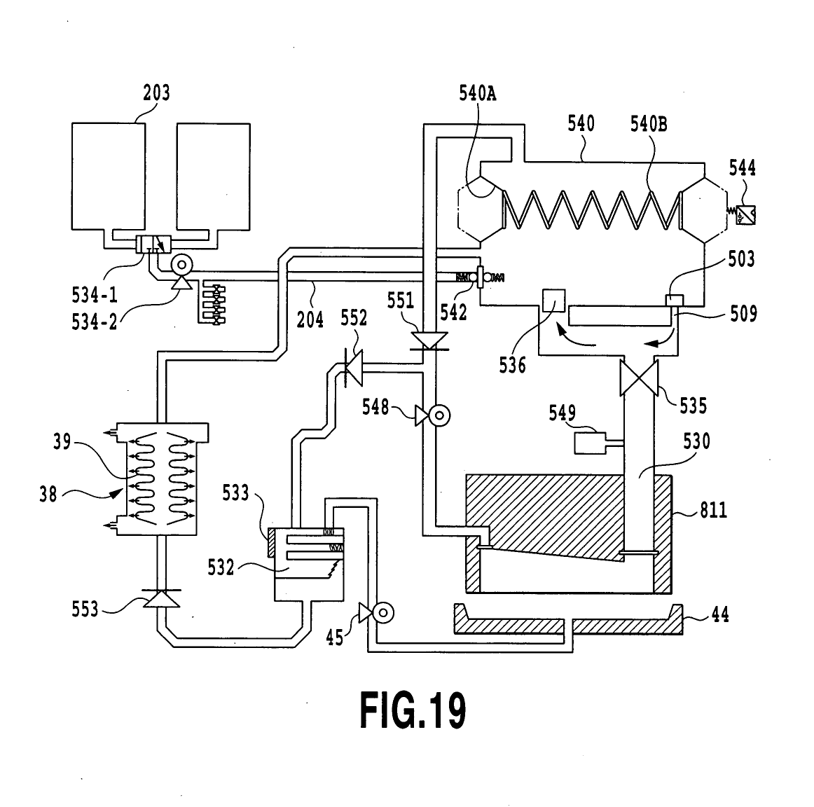

6-3. Second Example (FIG. 19 to FIG. 21)

7. Superiority of this Invention

8. Others.

1. Outline of the Image Forming System (FIG. 1 and FIG. 2)

FIG. 1 and FIG. 2 are a block diagram and a schematic perspective view, respectively, showing an outline of the image forming system according to one embodiment of this invention. The image forming system of this embodiment generally comprises an information processing device 100 and an image forming apparatus 200. The image forming apparatus 200 has a medium transport device 117 and a printer complex system 400, the latter being made up of a plurality of independent engines or printer units (also referred to as printing apparatus) 116-1 to 116-5.

Here, the information processing device 100 is a source of image data to be formed. It divides one page of image into a plurality of sections and supplies the divided image data to the plurality of printer units 116-1 to 116-5 making up the printer complex system 400. The medium transport device 117 feeds a print medium 206, whose width size corresponds to a range printed by an array of printer units 116-1 to 116-5. It also outputs a signal defining a print start position of each of the printer units 116-1 to 116-5 when it detects an end of the print medium.

The printer complex system 400 has a plurality (in this case, five) of printer units 116-1 to 116-5 arrayed to print their assigned divided areas of a whole print area on the print medium 206. Each of the printer units, based on the divided image data supplied from the information processing device 100, performs a printing operation independently of one another on the assigned, divided print areas at timings defined by the medium transport device 117. Each printer unit has print heads for ejecting yellow (Y), magenta (M), cyan (C) and black (K) inks respectively and which are supplied their color inks from an ink supply source, i.e., ink tanks 203Y, 203M, 203C and 203K.

2. Information Processing Device (FIG. 1 to FIG. 7)

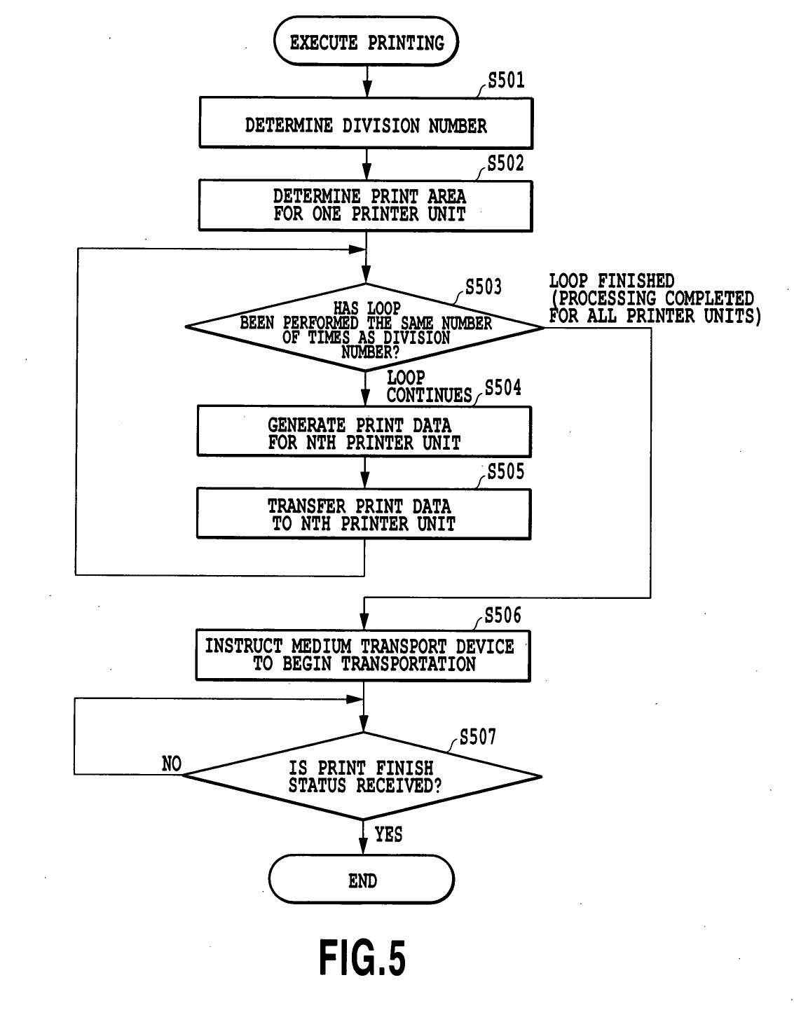

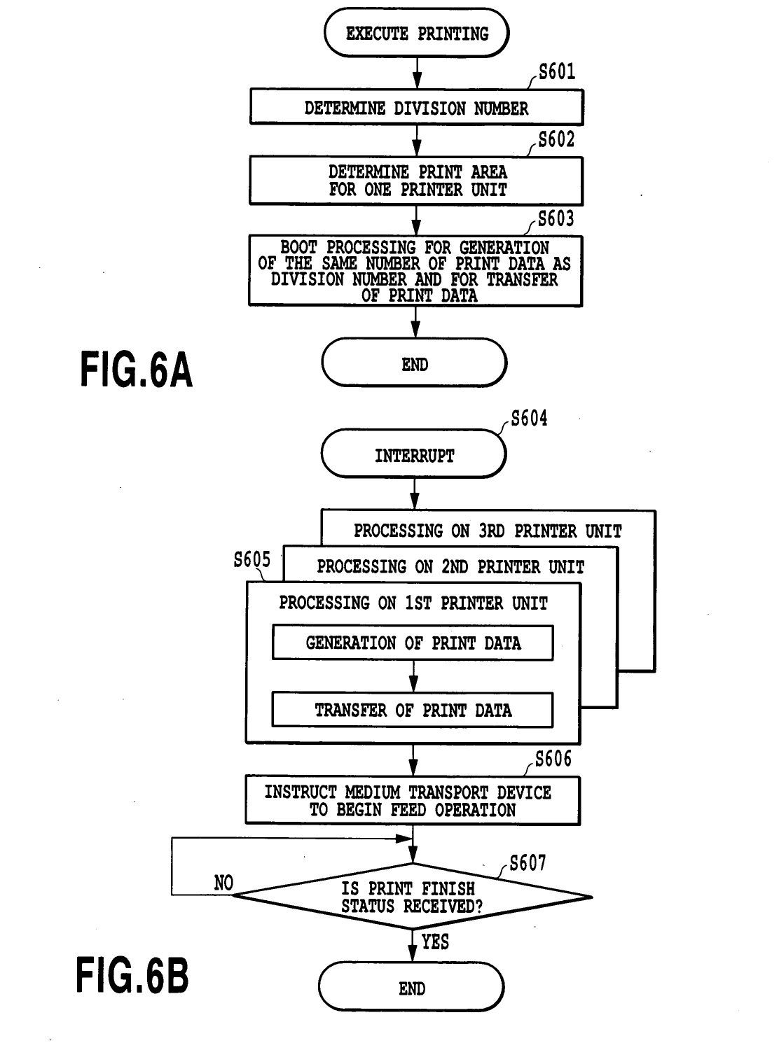

In FIG. 1, a CPU 101 is a central processing unit that performs an overall system control on the information processing device 100. In the information processing device 100, the CPU 101 under the control of an operating system (OS) executes processing defined by an application program for image data generation and editing, by an image dividing program of this embodiment (detailed later in connection with FIG. 5, FIG. 6A and FIG. 6B), by a control program (printer driver) for the printer units 116-1 to 116-5, and by a program governing the procedure shown in FIG. 11.

A system bus for the CPU 101 has a hierarchical structure. The CPU 101 is connected through a host/PCI bridge 102 to a local bus, such as PCI bus, and further connected through a PCI/ISA bridge 105 to an ISA bus and various devices on the bus.

A main memory 103 is a RAM (Random Access Memory) to temporarily store the OS, application programs and control program and is also used as a work area for these programs. These programs are loaded into the RAM from a hard disk drive HDD 104, for example. The system bus has a high-speed memory called cache memory 120 using SRAM (Static RAM), which stores such codes and data as the CPU 101 accesses at all times.

A ROM (Read Only Memory) 112 stores a program (Basic Input Output System or BIOS) for controlling input/output devices, such as keyboard 114, mouse 115, CDD 111 and FDD 110, an initialization program that is activated when the system power is turned on, and a self-diagnostic program. An EEPROM (Electronic Erasable ROM) 113 is a nonvolatile memory to store a variety of permanently used parameters.

A video controller 106 reads continuously and cyclically RGB display data written into a VRAM (Video RAM) 107 and transfers them as a screen refresh signal to a display 108, such as CRT, LCD and PDP (Plasma Display Panel).

A communication interface 109 with the printer units 116-1 to 116-5 is connected to the PCI bus. Possible interfaces include, for example, bidirectional Centronix interface compatible with IEEE 1284 standard, USB (Universal Serial Bus) and Ethernet connection. FIG. 1 shows a configuration in which the information processing device 100 is connected through the communication interface 109 to a hub 140, which in turn is connected to the printer units 116-1 to 116-5 and the medium transport device 117. While this embodiment uses a wired type communication interface 109, a wireless LAN communication interface may also be used.

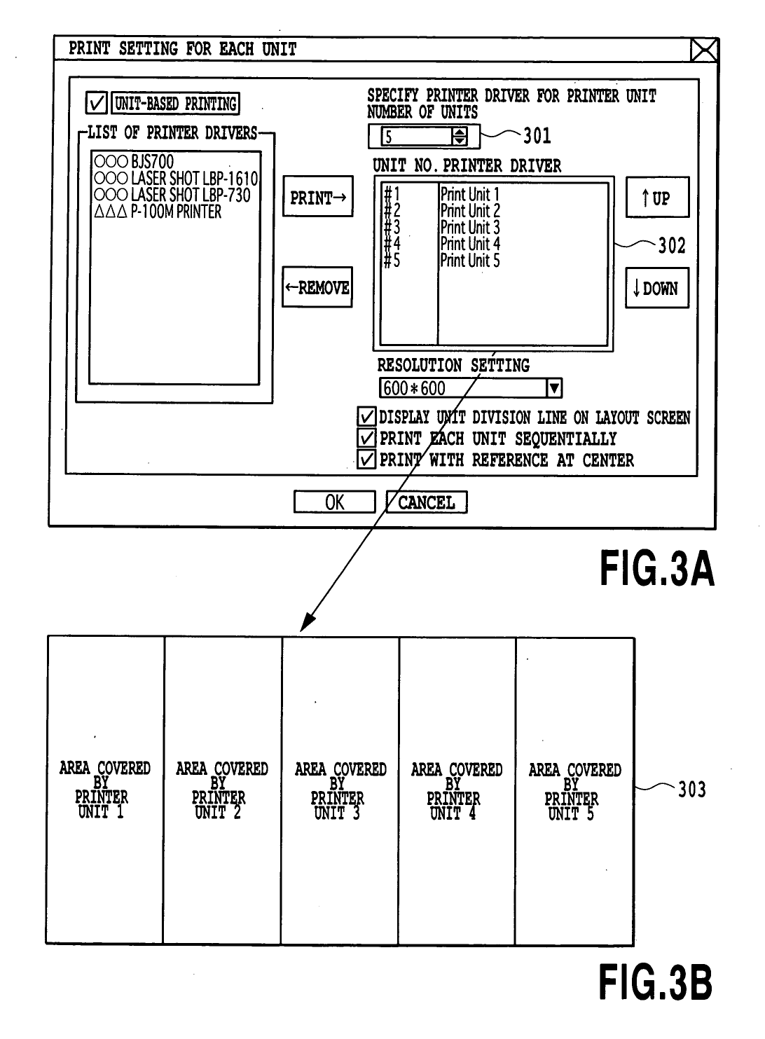

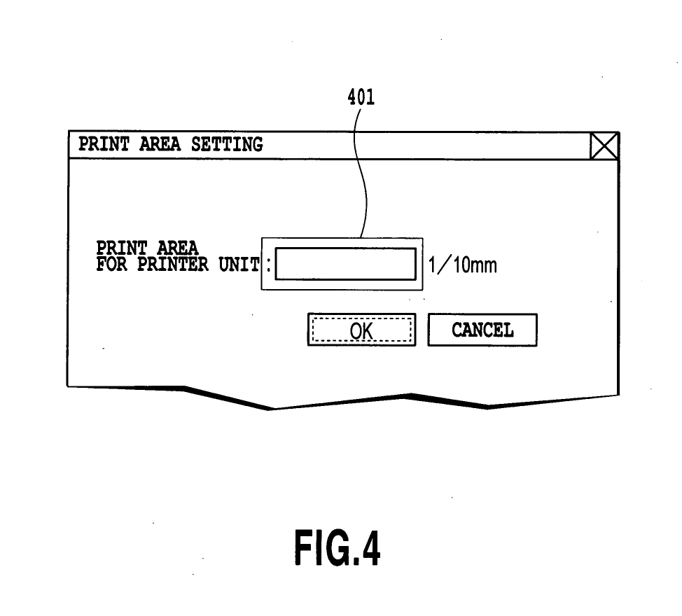

A printing program (printer driver) has three setting means: the first is for setting the number of printer units 116-1 to 116-5 connected to the information processing device 100 (which corresponds to the number of sections into which one page of image is divided; detailed later with reference to FIG. 3A and FIG. 3B); the second is for setting areas (divided widths) to be printed by the printer units 116-1 to 116-5 (detailed later with reference to FIG. 4); and the third is for setting a print area assignment indicating which part of one page is to be printed by which printer unit (see FIG. 3A and FIG. 3B). Based on the setting made by these setting means, the printing program divides one page of image and transfers the divided image data to the associated printer units 116-1 to 116-5 for printing.

As described above, since the printing program generates print data for the plurality of printer units 116-1 to 116-5 and transfers the print data to the individual printer units, the printing program itself or the print data generation processing and the print data transfer processing in the program are executed parallelly (multiprocess, multithread), completing the required processing quickly.

FIG. 3A and FIG. 3B show one example setting screen on the display unit 108 to set the number of printer units 116-1 to 116-5 (division number) connected to the information processing device 100 and to set the print area assignment specifying which part of one page of image is to be printed by which of the printer units 116-1 to 116-5. This setting screen is controlled by the CPU 101 executing the printing program (printer driver).

In a unit number setting field 301 on the screen of the display unit 108, a number can be entered which specifies how many of the printer units are used to print one page of image. For example, if five printer units each having a printable width of 100 mm are arranged in a staggered manner, as shown in FIG. 2, one page of image measuring 500 mm wide and a desired size long (in a medium transport direction) can be printed. In a print area assignment field 302, a setting is made as to which printer unit is assigned to which part of the image. In this embodiment, print areas each 100 mm wide are assigned, from left to right in FIG. 2, to the printer units 116-1 to 116-5 in that order. These print areas therefore are uniquely determined by physical locations of the printer units (see FIG. 2). When a print command is issued, the printer units print their assigned areas to form one whole image in combination, as schematically shown at reference number 303.

Although in the example shown in FIG. 3A and FIG. 3B the printer unit number (division number) setting and the print area assignment setting are made on the screen of the display unit 108, these settings can be made using registry information held by OS or an independent environment setting file.

FIG. 4 shows an example setting screen of the printer driver to set a width of each print area (divided section width) to be printed by the printer units 116-1 to 116-5. In a setting field 401 a print area width (divided section width) for all printer units can be set in step of 0.1 mm by an input device such as keyboard and mouse.

While a common value can be used to specify all the print area widths for the printer units 116-1 to 116-5 as described above, it is also possible to make setting individually for each printer unit 116-1 to 116-5. Instead of adopting the configuration in which the entered setting is accepted as in this example, the print area width may be automatically calculated from the printer unit number (division number) setting shown in FIG. 3A and FIG. 3B and the width of the print medium used.

Further, while this example employs an arrangement in which the printer units 116-1 to 116-5 are assigned print areas that do not overlap, the printer units assigned with adjoining print areas may be so arranged that their boundary portions overlap each other in order to prevent areas between the adjoining print areas from failing to be printed or being left blank due to a low arrangement accuracy.

FIG. 5 shows an example sequence of operations initiated when a print command is issued from the printer driver.

When this sequence is started by the CPU 101, the division number for one page of image to be printed is determined according to the setting information on the number of printer units connected to the information processing device 100 (division number) of FIG. 3A and FIG. 3B (step S501). Next, based on the print width setting information (FIG. 4) and the width of the print medium to be printed, the print area for each of the printer units 116-1 to 116-5 connected to the information processing device 100 is determined (step S502).

Next, according to the division number determined at step S501, the following processing is repeated (step S503). This processing includes one that generates print data individually for each of the printer units 116-1 to 116-5 based on the print area assignment setting (FIG. 3A and FIG. 3B) specifying which part of one page of image shall be printed by which printer unit (step S504), and one that transfers the print data generated by step S504 to each of the printer units 116-1 to 116-5 through the communication interface 109 (step S505). By repeating these processing the same number of times as the division number, the print data for each of the printer units 116-1 to 116-5 is generated and transferred from the information processing device 100.

Then, the medium transport device 117 is activated (step S506). When the required printing operation is finished and a completion status is received from the medium transport device 117 or the printer units 116-1 to 116-5 (step S507), this operation sequence is ended.

While the sequence of FIG. 5 performs the print data generation and transfer operation one printer unit after another 116-1 to 116-5, these processing may be performed parallelly.

FIG. 6A and FIG. 6B show one such example of operation sequence which makes for an increased operation speed.

When the sequence of FIG. 6A is started, the CPU 101 determines the division number for one page of image and the print area for one printer unit at step S601 and S602, which are similar to step S501 and S502 of FIG. 5. Next, the processing for each of the same number of individual printer units as the division number determined at step S601 (processes, threads) are started (step S603) and at the same time the processing performed at the initial stage of the printing operation is ended.

Then, as shown in FIG. 6B, when the CPU 101 generates an interrupt signal (step S604), the processing for each of the printer units started at step S603 is executed to perform the print data generation and the print data transfer to the individual printer units parallelly (step S605).

Then, the medium transport device 117 is started (step S606). After the desired printing operation is completed and a completion status is received from the medium transport device 117 or the printer units 116-1 to 116-5 (step S607), this sequence is ended.

In the above embodiment, how an image is divided according to the number of printer units can be made easily recognizable to an operator.

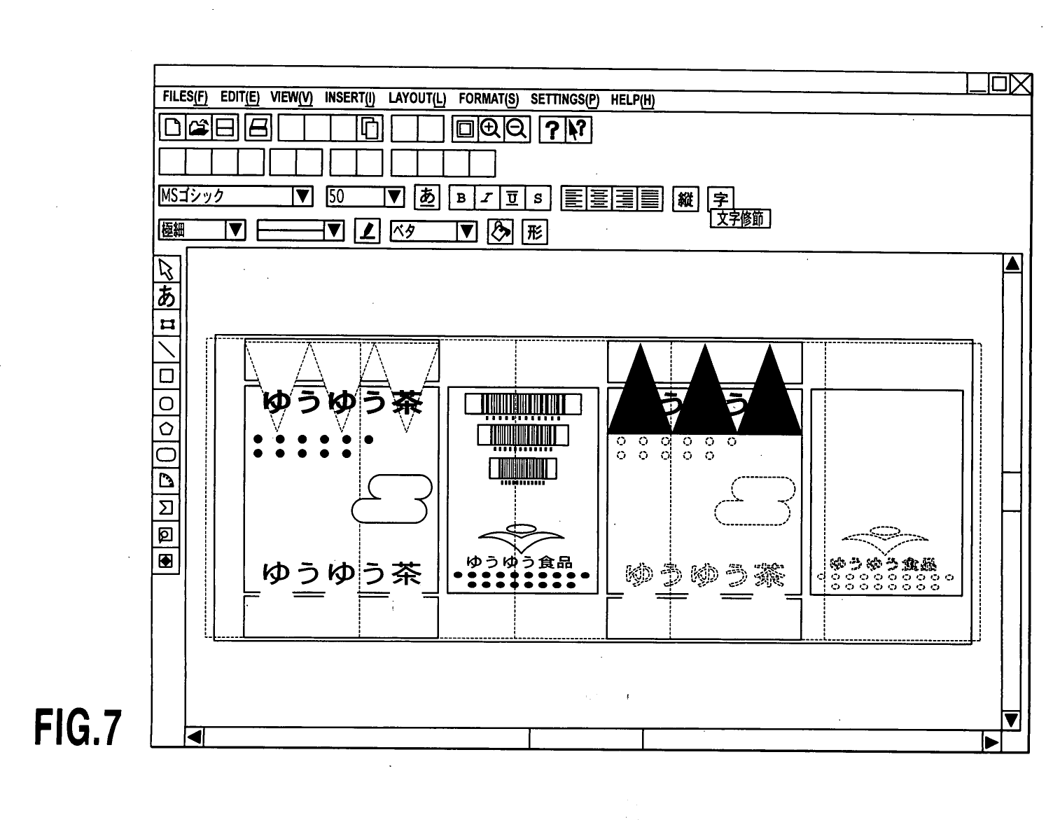

FIG. 7 illustrates an example of screen in which dividing lines, determined from the number of printer units (division number) set on the setting screen of FIG. 3A and FIG. 3B, are drawn in an image generated by the information processing device 100. That is, when the image generated and edited by the information processing device 100 is shown on the display 108, the dividing lines are also displayed as shown in FIG. 7, indicating to the operator which print area is covered by which of the printer units 116-1 to 116-5. The dividing lines can be displayed according to the division number setting information (FIG. 3A and FIG. 3B) and the print width information for each of the printer units 116-1 to 116-5 (FIG. 4).

3. Image Forming Apparatus (FIG. 2 and FIG. 8 to FIG. 10)

3-1. Printer Complex System (FIG. 2 and FIG. 8)

Referring again to FIG. 2, the information processing device 100 is connected to a plurality of printer units 116-1 to 116-5 and the medium transport device 117 through the hub 140 to transfer print data and operation start and end commands. The individual printer units 116-1 to 116-5 (generally referenced by 116 when no particular printer unit is specified) are also connected with the medium transport device 117 so that signals representing the detection of the front end of the print medium 206 and the setting of the printing start position and signals for synchronizing the medium transport speed with the printing operation (ink ejection) of the individual printer units are transferred between the printer units and the medium transport device.

Each of the printer units 116 is provided with, for example, four print heads 811Y, 811M, 811C and 811K (generally referenced by 811 when no particular print head is specified) for ejecting yellow (Y), magenta (M), cyan (C) and black (K) inks for continuous full color printing on the print medium 206. The order of arrangement of the print heads in the medium transport direction is the same for all printer units and therefore the order of color overlapping is also the same. The nozzles in each print head are arrayed in the widthwise direction of the print medium (perpendicular to the medium transport direction) at intervals of, for instance, 600 dpi (dots/inch) over four inches (about 100 mm) for instance and thus, as a whole, have a maximum print width of about 500 mm.

To the print heads 811Y, 811M, 811C, 811K of each printer unit 116, the associated color inks are supplied from ink sources, i.e., ink tanks 203Y, 203M, 203C, 203K, through dedicated tubes 204.

FIG. 8 shows an example configuration of a control system for each printer unit 116 according to this embodiment.

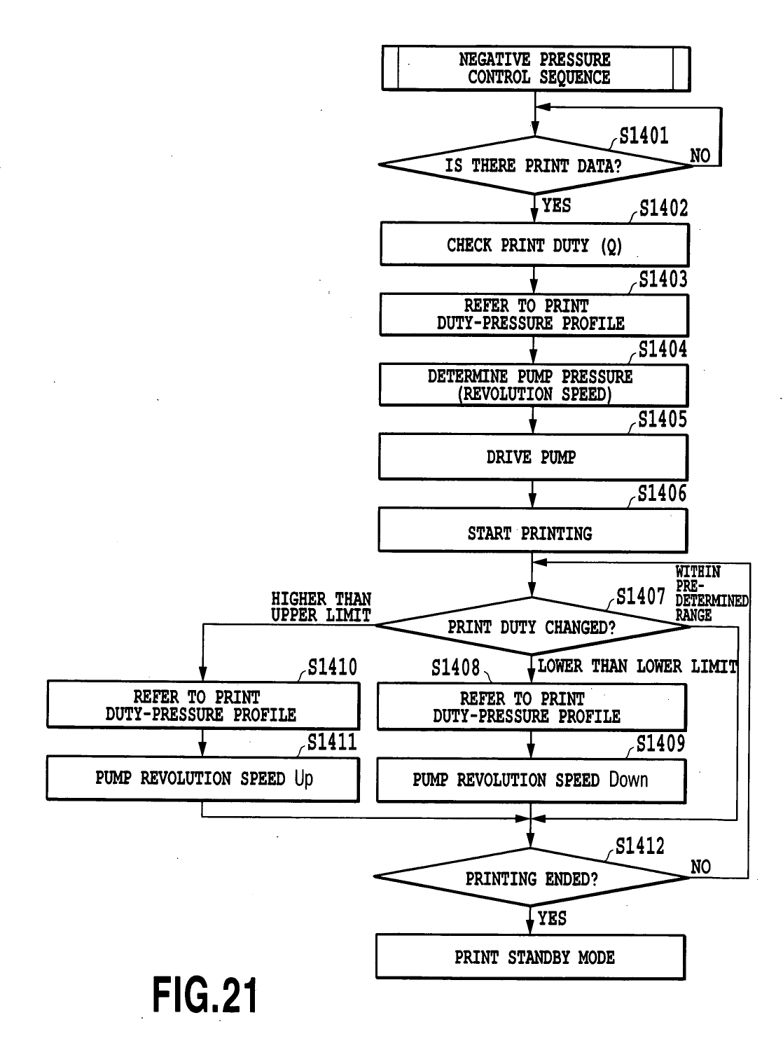

In the figure, denoted 800 is a CPU that performs an overall control on the printer unit 116 according to a program governing the procedure shown in FIG. 11 and FIG. 21; 803 a ROM that stores the program and fixed data; 805 a RAM that is used as a work memory area; and 814 a nonvolatile EEPROM to store parameters for each printer unit.

Denoted 802 is an interface controller to connect the printer unit 116 to the information processing device 100 through the USB cable. Designated 801 is a VRAM to develop image data of different colors. A memory controller 804 transfers the image data received through the interface controller 802 (print data generated by the processing of step S504 of FIG. 5 and sent from the information processing device 100 by the processing of step S505) to the VRAM 801 and performs control to read image data as the printing operation proceeds. When the interface controller 802 receives divided print data from the information processing device 100 through the USB cable, the CPU 800 analyzes a command attached to the print data and issues a command for developing the image data of different colors into bit maps in the VRAM 801. Upon receiving this instruction, the memory controller 804 writes the image data from the interface controller 802 into the VRAM 801 at high speed.

Denoted 810 is a control circuit to control the print heads of different colors 811Y, 811M, 811C, 811K. A capping motor 809 drives a capping mechanism (not shown) to cap a surface of the print heads 811 formed with nozzles. An ink system operation unit 808 includes a pump and valves for an ink system (including an ink supply system and a recovery system). The ink system operation unit 808 and the capping motor 809 are driven by a drive unit 807. When the printer unit 116 is not in use, the capping motor 809 is operated to move the print heads 811Y, 811M, 811C, 811K and the capping mechanism relative to each other for capping. When the image data to be printed is mapped in the VRAM 801, a print head up/down motor not shown and the capping motor 809 are driven to move the print heads 811Y, 811M, 811C, 811K and the capping mechanism relative to each other to uncap the print heads. Then, the printer unit waits for a print start signal from the medium transport device 117.

Denoted 806 is an input/output port 806. A drive unit 807 is connected with motors, operation unit and sensors (not shown) and transfers signals to and from the CPU 800. Designated 812 is a synchronization circuit which receives from the medium transport device 117 a print medium head signal and a position pulse signal that is in synchronism with the movement of the medium, and generates a timing signal to execute the printing operation in synchronism with these signals. That is, in synchronism with the position pulse signal produced as the print medium is transported, data in the VRAM 801 is read out at high speed by the memory controller 804 and transferred through the control circuit 810 to the print heads 811 for color printing.

3-2. Medium Transport Device (FIG. 2, FIG. 9 and FIG. 10)

Referring to FIG. 2, the medium transport device 117 is also suited for transporting a print medium which is large in the widthwise direction and has an arbitrary size in the transport direction. At a position facing the print heads 811 of the printer units 116-1 to 116-5 a media stage 202 for holding a print surface of the print medium 206 flat is installed. Since print media used have various thicknesses, means may be added to improve the level of intimate contact between the print medium and the media stage 202 so that the print surface of even a thick medium can be kept flat. A transport motor 205 drives a transport roller 205A to feed the print medium in contact with the upper surface of the media stage 202.

FIG. 9 shows an example configuration of a control system for the medium transport device 117 according to this embodiment.

In the figure, denoted 901 is a CPU that performs an overall control on the medium transport device 117 according to a program governing a procedure described later with reference to FIG. 11. Denoted 903 is a ROM that stores the program and fixed data. A RAM 904 is used as a work memory area.

Designated 902 is an interface that connects the medium transport device 117 to the information processing device 100. An operation panel 905 has an input unit for the user to enter various data and commands to the image forming apparatus and a display unit for visual display. In this example, it is provided in the medium transport device.

Denoted 908 is a suction motor which, as an example of means for improving the level of intimate contact between the print medium and the media stage 202, drives a vacuum pump to perform suction from below the media stage 202 through many fine holes formed in a transport surface of the media stage 202 to keep the print medium in intimate contact with the stage. Then, when a transport start command is received from the information processing device 100 through the interface 902, the CPU 901 first starts the suction motor 908 to draw the print medium 206 to the upper surface of the media stage 202 by suction.

Denoted 907 is a drive unit to drive the suction motor 908 and other operation units. Denoted 909 is a drive unit for the transport motor 205.

Designated 912 is a logic circuit that constitutes a servo system to perform a feedback control on the transport motor 205 to feed the print medium at a constant speed by receiving an output from the rotary encoder 910 mounted on a shaft of the transport motor 205. Here, the transport speed can be set at any desired speed by the CPU 901 writing a target speed value into the logic circuit 912. The rotary encoder 910 may be arranged coaxial with the transport rollers 205A, rather than being mounted on the transport motor 205. It may also be added later, instead of being incorporated into the medium transport device 117 from the beginning.

Also entered into the logic circuit 912 is an output of a medium sensor 911 provided upstream of the print position in the transport direction to detect that the front end of the print medium 206 has come near the print start position (the medium sensor 911 may also be added later, rather than being incorporated into the medium transport device 117 from the beginning). Then, the logic circuit 912 outputs an appropriate print command signal to each printer unit according to the distance from the position where the front end of the print medium is detected by the medium sensor 911 to the respective printer units. In this embodiment, since the printer units 116-1 to 116-5 are arranged in two rows in the transport direction, i.e., the printer units 116-1, 116-3, 116-5 are arranged on the upstream side and the printer units 116-2, 116-4 on the downstream side, as shown in FIG. 2, two kinds of print command signals are issued. Considering errors in the printer unit mounting positions, the print start signal 914 or 915 may be corrected for each printer unit independently according to the physical distance from the medium sensor 911 to each printer unit.

The logic circuit 912 appropriately converts an output of the rotary encoder 910 to produce a print medium position pulse signal 913 and the printer units perform the printing operation in synchronism with the position pulse signal 913. The resolution of the position pulse signal may be arbitrarily set. For example, it may be set to match an interval of a plurality of print lines.

The construction of the print medium transport unit in the medium transport device 117 is not limited to the one shown in FIG. 2 that has the fixed media stage 202. For example, it may have an endless transport belt wound around a pair of drums arranged upstream and downstream of the print position in the medium transport direction. A print medium may be carried on the transport belt as the belt is moved by the rotation of the drums. The print medium 206 to be transported may be of a cut paper type or a continuous roll paper type.

FIG. 10 shows still another construction of the print medium transport unit, which uses a print medium 206 of cut paper type and has a movable media stage 212 that can travel from the upstream side to the downstream side along rails 211. This movable media stage 212 can receive and carry a sheet of print medium at a predetermined position upstream of the print positions of the printer units 116-1 to 116-5 supported on a base 209 and then separate the sheet from itself on the downstream side. This construction is suited for carrying thick paper such as card board. The media stage 212 of this construction may also be provided with a means for improving the level of intimate contact between the print medium and the stage.

4. Outline of Operation of Image Forming System (FIG. 11)

FIG. 11 shows operation procedures interrelated among the information processing device 100, the printer units making up the printer complex system 400, and the medium transport device 117.

For execution of a printing operation, the information processing device 100 produces divided print data for each printer unit (step S1001) and sends them to the associated printer units. Upon reception of the data, the printer units 116 uncap their print heads and map data into the VRAM 801 (step S1041). When the divided data are completely received by all printer units 116-1 to 116-5, the information processing device 100 issues a transport start command to the medium transport device 117 (step S1002).

In response to this command, the medium transport device 117 first drives the suction motor 908 (step S1061) to draw the print medium 206 to the media stage 202 by suction. Next, it drives the transport motor 205 to start transporting the print medium 206 (step S1062). After the front end of the print medium is detected (step S1063) and when the print start position on the print medium reaches the respective printer units 116-1 to 116-5, the medium transport device 117 starts sending the print start signals 914 and 915 and the continuous position pulse signal 913 (step S1064). As described above, the print start signal is issued depending on the distance from the medium sensor 911 to each printer unit.

When the printing operations in the printer units 116 (step S1042) are finished, the printer units send a print completion status to the information processing device 100 (step S1043) and end their processing. At this time, the print heads 811 are capped by the capping mechanism to protect the nozzles (ink ejection openings) against being dried and clogged.

With the printing operation finished and the print medium 206 discharged from the media stage 202 (step S1065), the medium transport device 117 sends a transport completion status to the information processing device 100 (step S1066) and then stops the suction motor 908 and the transport motor 205 (step S1067, S1068) before ending its operation.

5. Signal System to Printer Complex System (FIG. 12)

FIG. 12 shows one example of signals transferred between the information processing device 100 and the medium transport device 117 and the printer units 116-1 to 116-5 making up the printer complex system. There are two largely separate signal systems connected to each of the printer units 116-1 to 116-5. One system concerns transmitting the divided print data (including operation start and end commands) supplied from the information processing device 100. The other system is assigned a function of transmitting the print timing signals (including print start signal and position pulse signal) supplied from the medium transport device 117.

In the example of FIG. 12, the first system has the hub 140 relaying signals between the information processing device 100 and the printer units 116-1 to 116-5. This hub 140 is connected to the information processing device 100 through, for example, a 100 base-T standard connector/cable 142 and to the printer units 116-1 to 116-5 through, for example, 10 base-T standard connector/cables 144.

The print timing signal transmission system in the example of FIG. 12 has a transfer control circuit 150 and a synchronization circuit 160. These circuits may be provided as a circuitry making up the logic circuit 912 of FIG. 9. The transfer control circuit 150 supplies an output (ENCODER) of the rotary encoder 910 mounted on the shaft of the transport motor 205 and a print medium front end detection output (TOF) produced by the medium sensor 911 to the synchronization circuit 160.

The synchronization circuit 160 is provided with a print operation enable circuit 166 that calculates a logical AND of operation ready signals PU1-RDY to PU5-RDY from the printer units 116-1 to 116-5 representing the completion of reception of the divided image data and which issues a signal PRN-START permitting the printing operation when all the printer units are completely ready (as when they are uncapped). The synchronization circuit 160 has an indication unit 167, such as LED, that produces an indication associated with the operation ready signals PU1-RDY to PU5-RDY so that the user can visually check the state of readiness of the printer units. The synchronization circuit 160 also has a reset circuit 168 for the user to forcibly reset the printer units and a pause circuit 169 for temporarily halting the printing operation, for instance after one complete page of print medium is printed out.

Further, the synchronization circuit 160 has a synchronization signal generation circuit 162 and a delay circuit 164. The synchronization signal generation circuit 162 generates from the encoder output (ENCODER) the position pulse signal 913 (e.g., 300 pulses per inch of print medium transport distance) corresponding to the synchronization signal (Hsync) to make the printer units perform synchronized printing operations. The delay circuit 164 generates from the print medium front end detection output (TOF) the print command signals 914, 915, delay signals corresponding to the positions of the printer units in the medium transport direction.

The printing operations of the printer units 116-1, 116-3, 116-5 arrayed on the upstream side in the print medium transport direction are initiated when they receive the print command signal (TOF-IN1) 914 representing a delay that corresponds to a distance from the medium sensor 911 to the positions of these printer units. If the distance from the medium sensor 911 to the printer unit positions is zero, the print command signal 914 is supplied almost simultaneously with the detection output TOF.

The printing operations of the printer units 116-2, 116-4 situated on the downstream side are started when they receive the print command signal (TOF-IN2) 915 representing a delay that corresponds to a distance from the medium sensor 911 to the positions of these printer units. In this embodiment, the distance from the medium sensor 911 to the these printer units (116-2 and 116-4) is set to 450 mm, and therefore if the position pulse signal 913 which serves as a synchronization signal (Hsync) is 300 pulses per inch (25.4 mm) of print medium transport distance, the print command signal 915 is issued 5,315 pulses after the detection output (TOF).

In order to make a fine correction on the print positions of individual printer units in the medium transport direction as described above, or to deal with a situation where the printer units are not arrayed in two rows, the print command signal may be issued to the individual printer units independently.

As shown in FIG. 12, the printer units 116-1 to 116-5 each receive the divided print data from the information processing device 100 and, in response to the print timing signal from the medium transport device 117, performs the printing operation independently. That is, each of the printer units 116-1 to 116-5 forms a complete unit in terms of the signal system, with the print data and print timing not transmitted through one printer unit to another. Each printer unit has its own means (shift register and latch circuit) to arrange the print data according to its dedicated print heads 811Y-811K and the nozzles of the print heads and performs ink ejection at specified timings. In other words, the printer units 116-1 to 116-5 each have similar hardware and perform their operation according to the similar software, so that the operation of one printer unit does not directly affect the operation of another. These printer units cooperate as a whole to print one page of image data.

While in this embodiment the print timing signals (including print start signal and position pulse signal) are supplied from the medium transport device 117, i.e., each printer unit prints the print data according to an instruction from the medium transport device 117, this instruction may be supplied, for example, from the information processing device 100 if the device 100 comprehends the print medium transport state. In that case, the information processing device 100 may send with a predetermined delay the data to each printer unit or send the data attached with null data corresponding to the delay.

6. Ink System of Printer Complex System and Printer Units (FIG. 13 to FIG. 21)

6-1. Basic Configuration of Ink System (FIG. 13 and FIG. 14A to FIG. 14D)

The printer units 116-1 to 116-5 of this embodiment can be operated independently of each other and individually have an independent ink system including an ink supply system and a recovery system for each print head 811.

FIG. 13 is a schematic diagram showing a configuration of the ink supply system of the ink system. As shown in the figure, to the print heads 811Y, 811M, 811C, 811K of each printer unit 116, the associated color inks are distributed and supplied from ink sources or ink tanks (also referred to as main tanks) 203Y, 203M, 203C, 203K through dedicated tubes 204Y, 204M, 204C, 204K. As for the ink supply method, the ink supply system may be in fluid communication with the ink tanks at all times to supply ink continuously or, as described later, come into fluid communication only when the volume of ink held in the ink supply unit provided for each print head runs low, thereby supplying ink intermittently.

The recovery system of this embodiment has caps to cover the nozzle forming surfaces of the print heads 811 to receive ink forced out from the nozzles and is so arranged as to circulate the forced-out ink for reuse.

The caps may be provided below a transport plane of the print medium 206, i.e., inside the media stage 202, and arranged to be able to face or contact the nozzle forming surface of the print heads. Considering the use of a continuous print medium in the form of rolled paper, the caps may be arranged above the transport plane of the print medium 206, i.e., on the same side as the print heads 811, to allow the recovery operation to be executed without having to remove the print medium.

FIG. 14A to FIG. 14C shows one such example configuration. In each printer unit 116, the print heads 811Y, 811M, 811C, 811K are each removably installed by an appropriate holding means and, in the held state, can be moved vertically up and down. The caps 44Y, 44M, 44C, 44K (generally referenced by 44 when no particular cap is specified) for the associated print heads are held horizontally movable.

FIG. 14A shows a non-printing state, as during standby state, in which the individual caps 44 are in contact with the nozzle forming faces of the print heads 811. When the print heads move out of this state for a printing operation, the print heads 811 are raised temporarily and the caps 44 retracted to the right, as shown in FIG. 14B, and then the print heads 811 are lowered through gaps between the caps. Then, as shown in FIG. 14C, the print heads 811 are protruded down from an opening 209A formed in the base holding the printer units 116 and set at predetermined positions facing the media stage 202 or print medium. Now the print heads are ready to execute the printing operation (ink ejection). Moving the print heads from this state to the standby state can be achieved by reversing the above procedure.

Each of the printer units 116, as shown in FIG. 14D, an enlarged view of FIG. 14A, can be fixed to the base 209 by fastening a nut 209C on a bolt 209B passed through an opening in a frame flange 116A of the printer unit. The base 209 is provided with a protruding, positioning pin 209P and the frame flange 116A of the printer unit is formed with a positioning hole 116P. Engaging them together can securely hold the printer units 116 at their predetermined positions on the base 209.

Portions with a fixing function and portions with a positioning function may be arranged at appropriate positions in appropriate numbers. The construction that performs these functions is not limited to the one shown. The portions with these two functions may not be separate but be integrally put together as by snap fastening. What is essential is that the printer units 116 can be removably mounted on the base 209 or image forming apparatus 200 and appropriately secured and positioned when mounted.

As described above, in this embodiment, each of the printer units 116 has its own complete, independent construction, except for the print medium transport system. Therefore, the printer units can individually be mounted to and dismounted from the image forming apparatus 200. Further, the ink supply system and the recovery system for the print heads 811 are also constructed as a complete, independent system in each of the printer units. This allows each of the printer units to be supplied individually an appropriate amount of ink or subjected to the recovery operation according to its operation state, i.e., the amount of print data printed.

Two representative examples of construction of the ink system will be described in detail as follows.

6-2. First Example (FIG. 15 to FIG. 18)

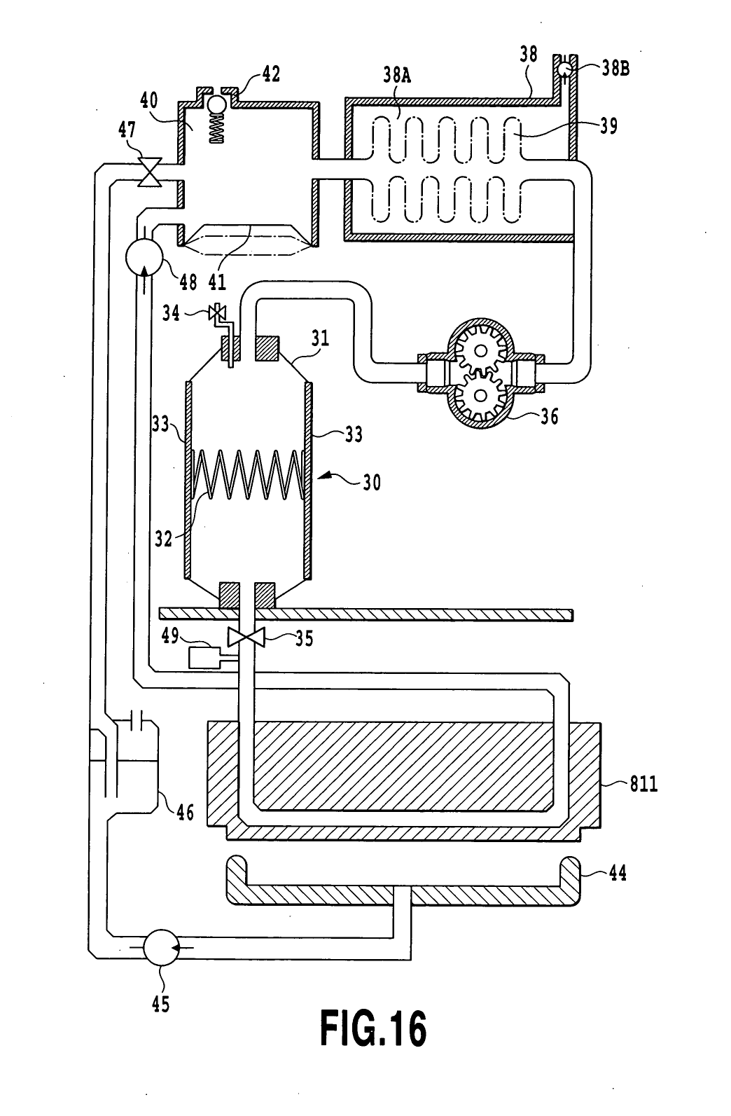

FIG. 15 shows an arrangement of essential portions of the ink system in one printer unit 116 and FIG. 16 shows an inner construction of the ink system for one print head. The print head 811 has two ink connection tubes, one of which is connected with a negative pressure chamber 30 to generate an appropriate negative pressure that balances with a holding force of an ink meniscus formed in ink nozzles of the print head, and the other is connected with an ink supply unit 40 (hereinafter referred to as subtanks) for each print head through a pump 48.

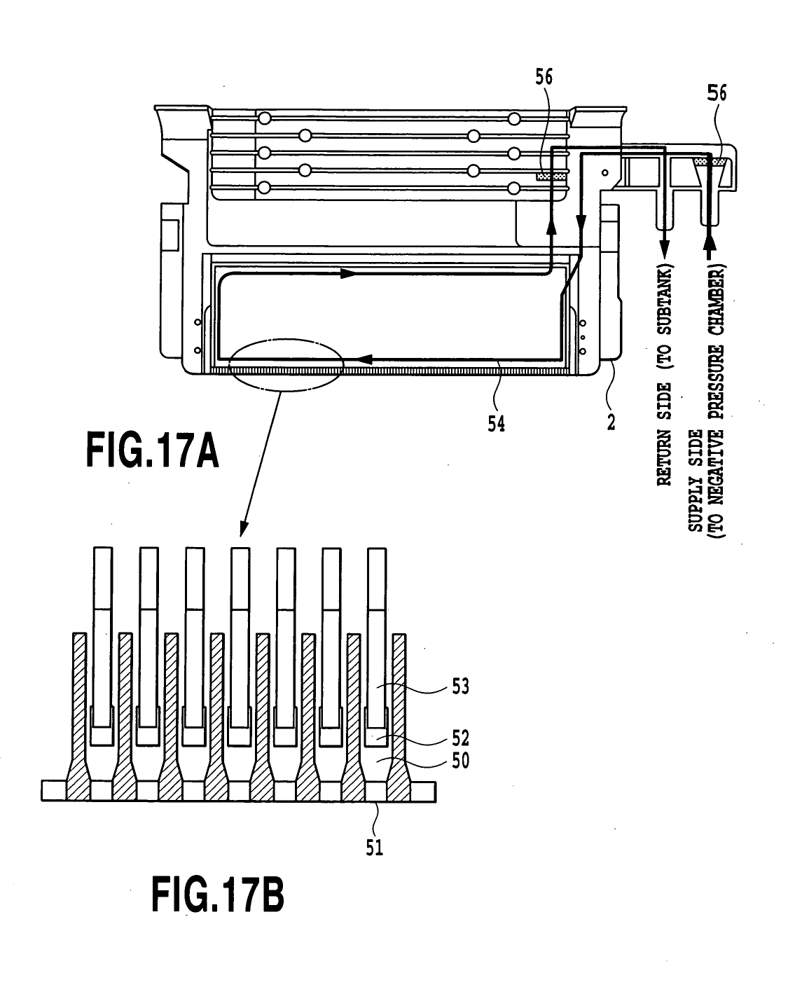

FIG. 17A and FIG. 17B show an ink path in the print head 811 and its partly enlarged view. The print head used in this embodiment has 2,400 nozzles 50 arranged at an interval of 600 dpi over a width of 4 inches. One end of each nozzle 50 is an ejection opening 51 and the other end is connected to an ink supply path 54. In each nozzle 50 there is provided an electrothermal transducer (heater) 52 which as an element for generating energy to eject ink produces a thermal energy to heat ink and generate a bubble in it as the heater is energized. Energizing the heater 52 for 1-5 μseconds heats ink and begins to cause a film boiling at 300° C. at the heater surface. As a result, the ink is applied an inertial force and ejected from the ejection opening 51 onto a print medium, forming an image on it. In each nozzle 50 a nozzle valve 53 is installed as a fluid control element. This member is displaced as a bubble is formed in ink to effectively apply an inertial force to the ink on the ejection opening side and, on the supply path side, prevent a pressure wave from propagating. Denoted 56 is a filter provided on both the supply side and return side of the ink supply path 54.

In FIG. 16, the negative pressure chamber 30 comprises an ink reservoir 31 made of a flexible member and a pair of opposing ink reserving plates 33 and reserves ink in a space defined by these members. Between the paired, opposing ink reserving plates 33 is installed a compression spring 32 that urges the ink reserving plates 33 in opposite, parting directions by its expansion force to produce a negative pressure. The negative pressure chamber 30 is located near the print head 811, so there is almost no pressure loss in a connection between them and the negative pressure of the negative pressure chamber 30 is almost equal to that of the head. If the ink demand of the print head 811 is so large that the ink supply from the pump 36 cannot catch up with it, this negative pressure chamber 30 works as a buffer helping the ink supply. More specifically, the paired ink reserving plates 33 are drawn to each other against the force of the spring 32 to reduce the inner volume of the negative pressure chamber 30 to supply ink. A valve 35 is provided between the negative pressure chamber 30 and the print head 811. On the print head 811 side of the valve 35 is installed a pressure sensor 49 that detects an inner pressure of the print head 811. Shown at 34 is an air vent valve to release air trapped inside the negative pressure chamber 30.

The negative pressure chamber 30 is connected with a mechanical ink pump (in the example shown, a gear pump) 36 for ink supply.

As for the valves including the valve 35 that are installed at various locations in the ink supply path, any type may be used as long as they can open or close the ink path or appropriately control the ink supply volume according to a control signal. For example, the valves may have a ball inserted in the ink path and a seat for receiving the ball. The ball is connected to a plunger that is advanced and retracted by a solenoid. By controlling the electricity to the solenoid, the ball is engaged with or disengaged from the seat to open or close the ink path. As for the valve 35, however, to allow for a highly responsive control of the negative pressure, a light device such as piezoelectric element may be used as an actuator.

As for the pump including the pump 36 that are installed at various locations in the ink supply path, any type may be used as long as they can deliver ink in response to a drive signal. It is noted, however, that in this embodiment the pump 36 is able to switch the ink flow direction and to adjust the ink flow. The gear pump shown in this example can selectively rotate in a direction that supplies ink to the negative pressure chamber 30 (forward rotation) or in a direction that draws out ink from the chamber (reverse rotation).

Further, the pump 36 is connected to a deaeration system 38 that removes gas components dissolved in the ink being delivered by the pump 36. The deaeration system 38 comprises an ink supply path made of a gas-liquid separation membrane 39 that passes a gas but not a liquid, a pressure reducing chamber 38A enclosing a space surrounding the ink supply path, and a pump 38B for reducing the inner pressure of the chamber 38A to a vacuum. The deaeration system 38 effectively removes, through the gas-liquid separation membrane 39, a gas from ink flowing in the ink path.

The deaeration system 38 is connected to a subtank 40 for accommodating an appropriate amount of ink that can be consumed by the printing. The subtank 40 has a buffer member 41 defining a part of the ink accommodation space and capable of moving or deforming according to the accommodated ink volume, and a joint 42 for ink communication with the ink tube 204 from the main tank 203. When the volume of ink in the subtank becomes small, the joint 42 is connected to a mating joint (not shown) of the ink tube 204 from the main tank 203 for ink supply. The construction of the joint 42 and the mating joint of the ink tube 204 may be of any type as long as they can close their opening when they are not connected to prevent ink leakage and can establish a flow path in a state isolated from an open air.

Instead of the connection and disconnection of the joints, the fluid communication may be established and interrupted by opening and closing a valve while keeping the supply path connected at all times. What is needed is that when the required volume of ink differs among the printer units depending on their divided image data, the ink supplies for the individual printer units do not interfere with one another. In this respect, the independence of each printer unit of this embodiment is assured.

The other end of the connection tube of the print head 811 is connected to the subtank 40 through the pump 48. The operation of the pump 48 and the pump 36 can circulate the ink through the subtank 40, negative pressure chamber 30 and print head 811.

A cap 44 is provided which constitutes a component of the recovery system that forcibly discharges ink from the nozzles of the print head 811 to refresh the head, i.e., to recover the ink ejection performance of the print head 811 or keep it in good condition. As described earlier with reference to FIG. 14A to FIG. 14C, during the printing operation the cap 44 can be retracted from the nozzle forming surface of the print head 811 to a position where it does not interfere with the printing. And when the printer unit is in a standby state or when the recovery operation is needed, the cap can cover the nozzle forming surface.

The cap 44 is connected to the subtank 40 through a pump 45. In performing the recovery operation, the pump 45 is driven with the print head capped and then the valve 35 is closed. Then, the pump 48 is operated to supply ink from the subtank 40 to the print head 811. This abruptly pressurizes the interior of the print head 811 to forcibly discharge a relatively large amount of ink from the nozzles, which recover their healthy state. The ink thus forced out temporarily tends to stay in the cap 44 but is quickly drawn into the subtank 40 by the running pump 45. That is, the relatively large volume of ink used for recovery operation can be collected for reuse without a waste. Denoted 46 is an air trap provided in the circulation path to remove air mixed in the circulating ink.

As described above, the printer units 116 and the print heads 118 of this embodiment are each provided with the above ink system, so that they can be controlled under various conditions separately from the image forming system and the image forming apparatus and also independently of other printer units. Therefore they can be replaced and maintained individually.

Preparation for Shipping

After the printer units 116 or print heads 811 have been manufactured, ink is poured from the joint 42 and loaded into the ink system by operating the pump 36, pumps 48 and 45. At this time, air initially present in the system is discharged from an exhaust port of the air trap 46, allowing the ink to be filled into the ink system. Then, a trial printing operation is performed for inspection and ageing of the print heads 811. Next, the pump 36 is reversed to make the ink flow backward to the subtank 40 to reduce the ink volume in the negative pressure chamber 30 and at the same time the cap 44 is brought into hermetic contact with each print head 811. This makes unlikely an ink leakage from within the ink system that would otherwise be caused by a force due to environmental changes, particularly temperature rises and atmospheric pressure falls, during transport after shipping from factory.

Preparation for Use

Prior to using the printer unit delivered to the user, the joint 42 is connected with the flow path leading to the main tank 203 and the pump 36 is rotated forwardly to feed ink into the negative pressure chamber 30. Further, the pump 45 is driven and kept in operation to remove bubbles in the flow path and then the valve 35 is closed. Then, the pump 48 is operated to supply ink from the subtank 40 to the print head 811. This rapidly pressurizes the interior of the print head 811, forcibly discharging a relatively large volume of ink from the nozzles, recovering the nozzles to a healthy state. The forced-out ink tends to stay temporarily in the cap 44 but the pump 45 already in operation quickly draws ink into the subtank 40.

Standby for Printing

During the normal standby state prior to starting the printing operation, an arrangement is made to ensure that a negative pressure about 20-150 mmAq lower than the atmospheric pressure is applied to the print head 811. However, if the print heads 811 are kept at this high negative pressure, the ink supply to the print head 811 during the printing operation is degraded, making it impossible to drive the head at high frequency. Thus, when print data is received (step S1041 of FIG. 11), the pump 36 is driven forwardly to perform a preliminary ink supply to feed a predetermined amount of ink to the negative pressure chamber 30 and thereby mitigate the negative pressure acting on the print head 811.

Ink Supply Control During Printing

By feeding back an output of the pressure sensor 49 to properly control the negative pressure adjust valve 35 and pump 36, an appropriate volume of ink can be supplied according to a variety of print duties based on image data to be printed by the printer unit 116 or print head 811. For example, when a print duty is low, the pump 36 is forwardly driven at low speed and at the same time the negative pressure adjust valve 35 is operated with high-precision to stabilize the negative pressure for appropriate ink supply. When the print duty is high, the pump 36 is driven forwardly at high speed to increase the ink supply volume and at the same time the negative pressure adjust valve 35 is appropriately opened to increase the ink supply capability. Further, when the printing operation is stopped, the inertia of ink produces an ink supply pressure applying a static pressure to the heads, which may cause an ink leakage or degrade the print quality. To prevent this, this embodiment therefore immediately closes the negative pressure adjust valve 35.

As described later in connection with a second example of the ink system, the print duty may be calculated during the printing operation to control the ink system. In either case, this embodiment can apply an appropriate negative pressure to the print heads stably without regard to the print duty, thus assuring a high-speed, stable printing.

Others

During the recovery operation, the pump 45 is kept running with the print head capped and then the valve 35 is closed. In this state the pump 48 is operated to feed ink from the subtank 40 to the print head 811. As a result, the interior of the print head 811 is suddenly pressurized, forcing out a relatively large volume of ink from the nozzles. The nozzles are therefore recovered to the normal state. The forced-out ink tends to stay temporarily in the cap 44 but is quickly collected by the operating pump 45 and returned into the subtank 40. That is, the relatively large volume of ink used for recovery operation can be recovered for reuse without a waste.

After this, a wiper blade not shown (which may, for example, be secured to the outside of each cap 44 of FIG. 14A to FIG. 14C) wipes the nozzle forming surface of the print head 811 (for example, by raising the print head 811 and moving the cap 44 in a horizontal direction, as explained with reference to FIG. 14B). Further, a preliminary ink ejection into the cap 44 is performed. Now, the recovery operation to restore the ink ejection performance of the print head 811 to the normal state is complete.

An ink supply from the main tank 203 to the subtank 40 is performed through the joint 42.

Summary of Control on Ink System

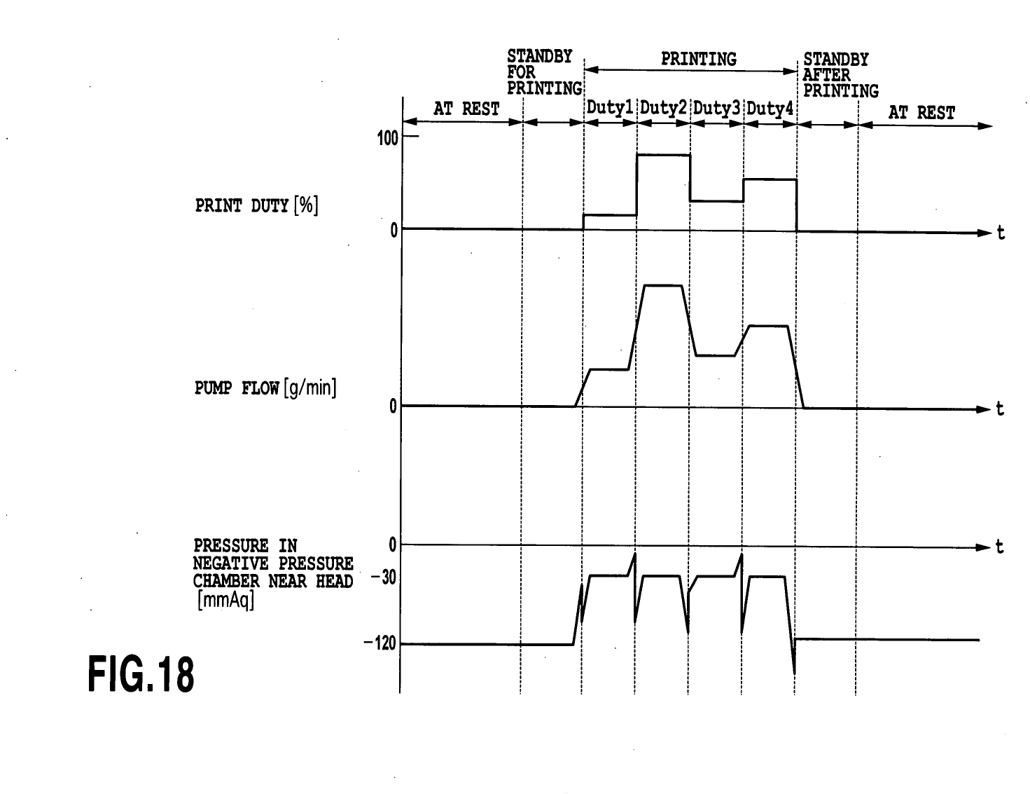

Referring to FIG. 18, the operation of the ink system of this embodiment will be explained from a standpoint of the print duty of the print head 811 and the negative pressure applied to the print head.

The “print duty” shown at the top tier in FIG. 18 covers various phases of operation when the printer unit is normally used: a rest phase in which the printer unit is not operated, a standby phase immediately before starting the printing operation, a print phase, and a post-printing standby phase in which the printer unit, immediately after the current print phase, waits for the next print phase.

During the print phase, since the amount of ink to be supplied differs according to the print duty, i.e., the rate of use of ink for printing, the print duty in this example is classified into four kinds, for each of which the pump flow is set as shown at the center tier of FIG. 18. It is noted that the print duty is shown as one example and can differ depending on image data.

The negative pressure applied to the print head is detected by the pressure sensor 49 mounted to the negative pressure chamber 30 which is located close to the head and whose negative pressure is almost equal to the print head. The detected pressure is shown at the lower tier in FIG. 18.

As described above, during the rest phase a relatively large negative pressure is applied to the interior of the print head (about −120 mmAq) to make the inner pressure stabilize even when subjected to environmental changes. During the standby phase the ink supply is started immediately before the printing operation as shown at the center tier of FIG. 18. By performing this control immediately before starting the printing operation, it is possible to have a sufficient ink supply immediately after the start of the printing operation, thereby enhancing the print quality.

Next, in “Duty1” during the print phase, since the negative pressure in the head increases the moment the printing operation is started, the pump flow is increased according to the detected value of the pressure sensor 49 to reduce the negative pressure in the head for an improved ink supply performance. In “Duty2” since the print duty becomes higher, the pump flow is further increased to prevent the negative pressure applied to the head from becoming large. As a result, the ink supply can follow even a high printing speed. In “Duty3” and “Duty4” the control is executed according to the print duty and pressure sensor reading to keep the head inner pressure at a desirable, low value. This can enhance the ink supply response and stability.

After the print phase is finished, a predetermined volume of ink is drawn out from the negative pressure chamber 30 to increase the negative pressure to prevent a possible leakage from the head that would otherwise occur when there are environmental changes such as pressure and temperature changes, thereby improving the reliability of the printer unit.

6-3. Second Example (FIG. 19 to FIG. 21)

FIG. 19 illustrates another example of construction of the ink system for one print head. Components identical with those of the first example (FIG. 16) are given like reference numbers. The print head 811 is provided with two ink connection tubes, one of which is connected with a negative pressure path 530 that forms an ink supply path and applies a desirable negative pressure, and the other is connected with a subtank 540 through a pump 548.

The negative pressure path 530 has a negative pressure adjust valve 535 and an ink pump 536 and is connected through these to the subtank 540. The subtank 540 has a flow path 509 which is connected to the negative pressure path 530 between the negative pressure adjust valve 535 and the ink pump 536. In the flow path 509 is installed a flow adjust valve 503. The ink pump 536 generates a negative pressure by generating a flow indicated by arrows in the paths 509 and 530 and also controls an ink supply to the negative pressure path 530.

Here, as for the valves including the valves 535 and 503 that are installed at various locations in the ink supply path, any type can be used as long as they can properly open or close the path or control the flow in response to a control signal. The valve 535 may the same as the valve 35 of the first example. The valve 503 may be one which has a plurality of paths and a plurality of valve discs capable of opening and closing these paths and which adjusts the flow by opening or closing a desired combination of the paths.

As for the pumps including the pump 536 that are installed at various locations in the ink supply path, any type can be used as long as they can deliver ink according to a drive signal. Particularly the pump 536 can switch the ink flow direction in this embodiment and, in cooperation with the flow adjust valve 503, can perform an ink flow adjustment with minimal pressure variations. In this example, the pump 536 can selectively deliver ink either in a direction that supplies ink to the negative pressure path 530 or in a direction that draws ink out. This pump may use a constant pressure, axial flow type pump that is driven by a motor (not shown) capable of controlling its rotation direction and revolution speed. As for the pump 548, a pump similar to the one 48 of the first example may be used. In the following, the operation of the pumps 536 and 548 in a direction that supplies ink to the print head 811 is called a forward rotation and the operation in the direction that draws ink out from the print head 811 is called a reverse rotation.

The subtank 540 comprises a pair of opposing movable members 540A made of a flexible material and a compression spring 540B disposed between them. The compression spring 540B urges the movable members 540A away from each other to produce a negative pressure by its expansion force. If the ink supply to the print head 811 is abrupt, the subtank works as a buffer helping the ink supply to the print head. The subtank 540 is provided with a pressure sensor 544 used to detect a displacement of the movable members 540A for executing an ink replenishment. When the ink in the subtank is found to be running low, ink is supplied from the main tank 203 through the tube 204 and joint 42, as in the first example. In FIG. 19, two main tanks 203 are provided for each color and one of them is selected by a direction control valve 534-1 to supply ink to the subtank 540 by the operation of a pump 534-2.

The other end of the connection tube of the print head 811 is connected to the subtank 540 through the pump 548 and a check valve 551. The operation of the pump 548 and pump 536 can circulate the ink from the subtank 540 to the print head 811 and from the print head to the subtank.

The ink collected into the cap 44 as a result of the recovery operation is delivered by the suction pump 45 into a bubble removing chamber 532 in which the ink is removed of air (bubble removal). An air-liquid separation membrane 533 made of a material that transmits a gas but not a liquid discharges air from the bubble removing chamber 532 and prevents water evaporation. The connection tube connecting the subtank 540 and the print head 811 branches at a position between the pump 548 and the check valve 551 and is connected through a check valve 552 to the bubble removing chamber 532. The ink that has passed through the bubble removing chamber 532 is returned to the subtank 540 through a check valve 533 and the deaeration system 38 described in the first example.

Drive signals and sensor outputs for the pumps and valves are transferred to and from a control unit including the CPU 800 and I/O port 806 in FIG. 8.

As described above, the provision of the ink system of this example allows each printer unit to be controlled under various conditions separately from the image forming system and the image forming apparatus and also independently of other printer units. Therefore, they can be replaced and maintained individually as in the first example.

In preparation for shipping after the printer units and the print heads 811 are manufactured, the pump 534-2 is operated to pour ink from the joint 42 into the subtank 540, and the pumps 548, 536 are operated appropriately to circulate ink in the ink system, filling the ink system with ink. In this process, air initially present in the ink system is discharged from the air-liquid separation membrane 533 of the bubble removing chamber 532. Further, the ink containing air present in nozzles can be forced out from the ejection openings by closing the valve 535 and forwardly operating the pump 548 to pressurize the interior of the print head. Then, after the trial printing operation is done, the negative pressure adjust valve 535 for shipping is closed, the joint 42 disconnected and the print heads capped.

Prior to using the printer unit delivered to the user, the joint 42 is connected with the flow path leading to the main tank 203 and the pumps 548, 536 are operated properly to circulate ink in the ink system. With the print head capped, the valve 535 is closed and the pump 548 is operated forwardly to pressurize the interior of the print head 811, forcing out ink containing air present in the nozzles from the nozzle openings. At the same time the pump 45 is operated to circulate the ink received in the cap to the subtank 40 through the bubble removing chamber 532 and the deaeration system 38.

During the normal standby state prior to starting the printing operation, the negative pressure is set high. When a print signal is entered (step S1041 in FIG. 11), ink is delivered from the main tank 203 to the subtank 540 to alleviate the negative pressure acting on the print head 811. During the printing operation, the negative pressure adjust valve 535 and the pump 536 are properly controlled to supply an appropriate amount of ink according to a variety of print duties based on image data to be printed by the printer unit 116 or print head 811. Further, when the printing operation is stopped, this embodiment immediately closes the negative pressure adjust valve 535. Also during the recovery operation (maintenance operation) and ink replenishing operation, various portions are properly controlled.

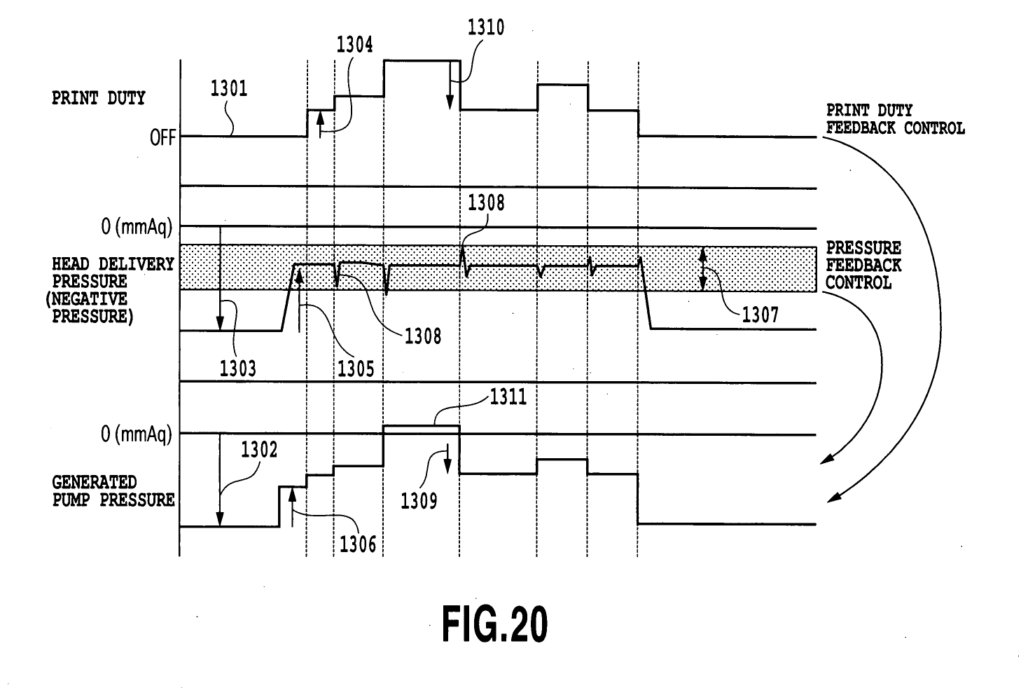

By referring to FIG. 20, the operation of the ink system of this embodiment will be explained from a standpoint of the print duty of the print head 811 and the pressure acting on the print head.

During a non-ejection state 1301, in order to get the print head 811 ready to eject ink, the pump 536 generates a predetermined pressure as indicated at 1302 to control the pressure of the print head as indicated at 1303. Before starting an ink ejection from the print head (shown at 1304), the pressure generated by the pump is set close to the atmosphere (0 mmAq) (the negative pressure is reduced) (indicated at 1306, 1305). After the printing operation is started, the pump-generated pressure is adjusted according to changes in the print duty. These controls alleviate the pressure changes due to ink ejection to keep the negative pressure within a desirable ejection permissible range 1307. If setting the pressure close to the atmosphere fails to bring it into the ejection permissible range, the pump 536 is operated forwardly (rotated in the ink supply direction) to control it to a pressure higher than the atmospheric pressure (positive pressure) 1311. Conversely, if the print duty decreases (at 1310), the pump-generated pressure is set to a negative pressure (at 1309).

By controlling the operation of the pump 536 based on the print duty, the negative pressure can be kept within the desirable ejection permissible range 1307 although irregular pressure changes (at 1308) are observed which are caused by a delay in the response to print duty changes due to an ink inertia.

FIG. 21 shows a pressure control procedure in this example. In the configuration of the control system for the printer unit shown in FIG. 8, this procedure can be executed by the CPU 800 according to a program stored in the ROM 803.

First, a check is made as to whether the print data is present (step S1401). If there is the print data, the print duty per unit print area is counted (step S1402). Then, a profile representing a print head pressure change versus the print duty which is stored in advance in the printer unit body (e.g., EEPROM 804) is referenced (step 1403), and a pressure setting value for the pump 536 that matches the count value is determined (step S1404). Then, the pump 536 is operated to control the pressure in the print head within the ejection permissible range.

After the printing operation has started (step S1406), a check is made to see if the print duty per unit print area has changed by more than a predetermined range from that print duty from which the current pump setting was obtained. If such a change is found, a pressure change profile of the print head with respect to the print duty is referenced again and the setting of the pump-generated pressure is changed (step S1407 to S1411). That is, when the print duty exceeds an upper limit of the predetermined range, the pressure in the print head becomes significantly lower than the atmospheric pressure, so that either the pump (reverse) revolution speed is reduced or the pump is rotated forwardly to control the print head pressure within the ejection permissible range. Conversely, when the print duty falls below a lower limit of the predetermined range, the pump (reverse) revolution speed is reduced to control the print head pressure in the within the ejection permissible range. The above sequence of control is repeated until the printing is finished (step S1412), after which the control moves to the standby mode.

Instead of using the above software processing, the counter for counting bits making up the image data and means for controlling a motor to drive the pump 536 according to the count value can also be constructed of hardware. Further, rather than performing control when the print duty changes as the printing operation proceeds, it is possible to determine a pump control curve based on the print data in advance and to feedforward-control the pump according to the control curve. The pump control may also be done by a local feedback loop based on the detection output of the pressure sensor 549 that detects an actual head pressure (the pressure sensor 544 may be used if the pressure in the subtank 540 can be deemed essentially equal to the head pressure).

7. Superiority of This Embodiment

As described above, a plurality of printer units employed in this embodiment are independent of each other. That is, these printer units are independent of each other not only in terms of space (or arrangement) relationship but also in terms of signal system and ink system.

Where the overall length of the print head is increased to deal with a variety of sizes of print medium by arranging an appropriate number of short print heads in line on one and the same base member, it is difficult to quickly design various line printers at low cost by flexibly complying with various needs of the user. With this embodiment, however, a plurality of printer units can be arranged in an appropriate layout, allowing an image forming apparatus or system conforming to the user needs to be provided quickly and at low cost. Further, if some of the nozzles of a print head should fail, only a small maintenance work is needed, such as replacing the failed head, which is advantageous in terms of maintenance.

Where the overall length of the print head is increased to deal with a variety of sizes of print medium by arranging an appropriate number of short print heads in line on one and the same base member, the hardware and software for the print head control system must be changed according to the construction of the print head. Unlike this construction, the present embodiment is characterized in that each of the printer units receives divided print data from the host device or information processing device and performs the printing operation independently of each other in response to a print timing signal supplied from the medium transport device. That is, the individual printer units are independent and complete in terms of the signal system. Because of this configuration, the present embodiment is advantageous in providing the image forming apparatus conforming to the user needs quickly and at low cost. This embodiment is also advantageous in terms of maintainability as when a part of the signal system fails and needs to be repaired. Also in the information processing device, or host device, what is needed to deal with various sizes of print medium is setting the division number and preparing a hub according to the number of printer units, without having to make large specification changes in connection with the mapping of image data and with the data transfer system. This alleviates the design conditions for the image forming system as a whole and thus makes it possible to provide such an image forming system quickly and at low cost.

Further, in this embodiment each of the printer units has its own independent ink system (including the ink supply system and recovery system for each print head). This configuration allows for the supply of an appropriate ink volume and the performance of recovery operation according to the operation state of each printer unit, i.e., the amount of print data printed. This embodiment also allows the individual printer units to be controlled under various conditions separately from the image forming system and the image forming apparatus and also independently of other printer units. Thus, they can be replaced and handled individually. As described above, this invention allows for the replacement and handling of individual printer units and can also be applied to those printer units that are removably mounted on a support member of an image forming system and an image forming apparatus.

8. Others

It is noted that this invention is not limited to the above-described embodiments and their variations and that various changes may be made within a spirit of this invention.

For example, the number of printer units and the number of print heads (the number of inks) are not limited to those described in the above embodiments and may be set to desired numbers. Their arrangement can also be determined appropriately. It is therefore one of the features of this invention to be able to quickly provide an image forming apparatus or system conforming to the needs of the user by using an appropriate number of printer units and arranging them in a desired layout.

Although in the above embodiments, the printer units have been described to have print heads of equal lengths (print widths), the print heads may have different lengths among the printer units. A variety of sizes of print medium may be dealt with by preparing a plurality of kinds of these printer units whose print heads differ in length among the printer units.

Further, for facilitating the manufacture of the image forming apparatus and for improved maintainability, it is possible to add means for removably holding the printer units or the print heads and means for connecting and disconnecting the signal system or the ink system with a simple operation.

1-31. (canceled)

32. An image forming system comprising:
an information processing device serving as a source of image data to be printed;
a plurality of printer units separate from each other, each independently having a print head, with each print head having print elements arrayed therein in a predetermined direction, the plurality of printer units being arranged in a main scan direction in a state in which the predetermined direction is set to the main scan direction; and
a medium transport device to feed a print medium relative to the plurality of printer units;
wherein the information processing device includes:
means for generating a plurality of print data by dividing the image data into corresponding positions of the printer units in the main scan direction; and
means for transferring the generated print data to the corresponding printer units, and
wherein each of the plurality of printer units includes:
means for executing a printing operation for the transferred print data in response to a print timing signal supplied in synchronism with transport of the print medium by the transport device.

33. An image processing method for an image forming system comprised of an information processing device serving as a source of image data to be printed, a plurality of printer units separate from each other, each independently having a print head, with each print head having print elements arrayed therein in a predetermined direction, the plurality of printer units being arranged in a main scan direction in a state in which the predetermined direction is set to the main scan direction and a medium transport device to feed a print medium relative to the plurality of printer units, the method comprising the steps of:
causing the information processing device to generate a plurality of print data by dividing the image data into corresponding positions of the printer units in the main scan direction;
causing the information processing device to transfer the generated print data to the corresponding printer units; and
causing the plurality of printer units to execute a printing operation for the transferred print data in response to a print timing signal supplied in synchronism with transport of the print medium by the transport device.

34. An information processing device for use with an image forming system, including a plurality of printer units separate from each other, each independently having a print head, with each print head having print elements arrayed therein in a predetermined direction, the plurality of printer units being arranged in a main scan direction in a state in which the predetermined direction is set to the main scan direction, and a medium transport device to feed a print medium relative to the plurality of printer unit, said device comprising:
means for generating a plurality of print data by dividing image data into corresponding positions of the printer units in the main scan direction; and
means for transferring the generated print data to the corresponding printer units.

35. An information processing device as claimed in claim 34, further comprising means for recognizing the number of the printer units, and their respective assigned print areas in the main scan direction.

36. An information processing device as claimed in claim 35, further comprising means for setting a division number for the image data based on the recognized number of printer units.

37. An information processing device as claimed in claim 35, further comprising means for setting a width of the image to be divided based on the recognized number of printer units.

38. An information processing device as claimed in claim 35, wherein generation of the print data corresponding to the individual areas by the print data generation means and a transfer of the print data to the plurality of printer units by the data transfer means are processed in parallel, and the data transfer means transfers the print data to the plurality of printer units simultaneously.

39. An information processing device as claimed in claim 36, further comprising means for displaying on a layout screen boundary lines superimposed on an image to be printed, the boundary lines being determined according to the division number set by the division number setting means.

40. An information processing method for an image forming system comprised of an information processing device serving as a source of image data to be printed, a plurality of printer units separate from each other, each independently having a print head, with each print head having print elements arrayed therein in a predetermined direction, the plurality of printer units being arranged in a main scan direction in a state in which the predetermined direction is set to the main scan direction, and a medium transport device to feed a print medium relative to the plurality of printer units, said method comprising the steps of:
causing the information processing device to generate a plurality of print data by dividing the image into corresponding positions of the printer units in the main scan direction; and
causing the information processing device to transfer the generated print data to the corresponding printer units.

41. An image forming apparatus for use with an image forming system having an information processing device serving as a source of image data to be printed, comprising:
a plurality of printer units separate from each other, each independently having a print head, with each print head having print elements arrayed therein in a predetermined direction, the plurality of printer units being arranged in a main scan direction in a state in which the predetermined direction is set to the main scan direction; and
a medium transport device to feed a print medium relative to the plurality of printer units;
wherein each of the plurality of printer units includes:
means for executing a printing operation for the transferred print data in response to a print timing signal supplied in synchronism with transport of the print medium by the transport system.

42. An image forming apparatus as claimed in claim 41, wherein the plurality of printer units are arranged in the main scan direction within a range substantially equal to a total of array ranges of the print elements of the print heads of all the printer units, and the plurality of printer units extends also in a subscan direction which is a print medium transport direction, and the print timing signal includes a print start signal independently supplied to each of the printer units according to a position in the subscan direction and a print medium position signal commonly supplied to enable the plurality of printer units to execute a printing operation according to a position of the print medium being transported.

43. An image forming apparatus as claimed in claim 41, wherein said medium transport device comprises:
means for detecting a position of the print medium being transported; and
means for outputting the print timing signal according to the detected position.

44. An image forming apparatus as claimed in claim 43, wherein the plurality of printer units extends also in a subscan direction which is the print medium transport direction, and the print timing signal includes a print start signal independently supplied to each of the plurality of printer units according to a position in the subscan direction and a print medium position signal commonly supplied to enable the plurality of printer units to execute a printing operation according to a position of the print medium being transported.

45. A printer complex system, comprising:
a plurality of printer units separate from each other, each independently having a print head, with each print head having print elements arrayed therein in a predetermined direction;
a support member to arrange and support the plurality of printer units in a main scan direction in a state in which the predetermined direction is set to the main scan direction; and
a medium transport device to feed a print medium relative to the plurality of printer units,
wherein each of the plurality of printer units includes:
means for receiving print data which is divided into corresponding positions in the main scan direction; and
means for executing a printing operation of the received print data in response to a print timing signal supplied in synchronism with transport of the print medium by the transport device.

46. An image forming system comprising:
a plurality of printer units separate from each other, each independently having a print head, with each print head having print elements arrayed therein in a predetermined direction, the plurality of printer units being arranged so as to cooperate to print an image on a common print medium;
a medium transport device to feed the print medium relative to the plurality of printer units; and
an information processing device to supply a plurality of print data divided corresponding to the plurality of printer units:
wherein each of the plurality of printer units includes:
means for receiving the supplied print data;
means for holding the received print data in the bitmap format; and
means for executing a printing operation for the held print data in response to a print timing signal supplied in synchronism with the transport of the print medium by the transporting device.

47. An image forming system as claimed in claim 46, wherein the plurality of printer units are arranged in a main scan direction within a range substantially equal to a total of array ranges of the print elements of the print heads of all the printer units and in a state in which the predetermined direction is set to the main scan direction, and the plurality of printer units extends also in a subscan direction which is a print medium transport direction, and the print timing signal includes a print start signal independently supplied to each of the plurality of printer units according to a position in the subscan direction and a print medium position signal commonly supplied to enable the plurality of printer units to execute a printing operation according to a position of the print medium being transported.

48. An image forming apparatus for use with an image forming system having an information processing device to supply a plurality of print data divided corresponding to a plurality of printer units, the apparatus comprising:
a plurality of printer units separate from each other, each independently having a print head, with each print head having print elements arrayed therein in a predetermined direction, the plurality of printer units being arranged so as to cooperate to print an image on a common print medium; and
a medium transport device to feed the print medium relative to the plurality of printer units;
wherein each of the plurality of printer units includes:
means for receiving the supplied print data;
means for holding the received print data in the bitmap format; and
means for executing a printing operation for the held print data in response to a print timing signal supplied in synchronism with the transport of the print medium by the transport device.

49. An image forming apparatus as claimed in claim 48, wherein the plurality of printer units are arranged in a main scan direction within a range substantially equal to a total of array ranges of the print elements of the print heads of all the printer units and in a state in which the predetermined direction is set to the main scan direction, and the plurality of printer units extends also in a subscan direction which is a print medium transport direction, and the print timing signal includes a print start signal independently supplied to each of the plurality of printer units according to a position in the subscan direction and a print medium position signal commonly supplied to enable the plurality of printer units to execute a printing operation according to a position of the print medium being transported.

50. An image forming apparatus as claimed in claim 48, wherein said medium transport device comprises:
means for determining a position of the print medium being transported; and
means for outputting the print timing signal according to the direction.

51. An image forming apparatus as claimed in claim 50, wherein the plurality of printer units are arranged in a main scan direction within a range substantially equal to a total of array ranges of the print elements of the print heads of all the printer units and in a state in which the predetermined direction is set to the main scan direction, and the plurality of printer units extends also in a subscan direction which is a print medium transport direction, and the print timing signal includes a print start signal independently supplied to each of the plurality of printer units according to a position in the subscan direction and a print medium position signal commonly supplied to enable the plurality of printer units to execute a printing operation according to a position of the print medium being transported.

52. A printer complex system used for an image forming apparatus as claimed in claim 48, the system comprising:
a plurality of printer units separate from each other, each independently having a print head, with each print head having print elements arrayed therein in a predetermined direction;
a support member to arrange and support the plurality of printer units in a main scan direction in a state in which the predetermined direction is set to the main scan direction; and
a medium transport device to feed the print medium relative to the plurality of printer units,
wherein each of the plurality of printer units includes:
means for receiving the supplied print data;
means for holding the received print data in the bitmap format; and
means for executing a printing operation for the held print data in response to a print timing signal supplied in synchronism with the transport of the print medium by the transport device.

53. A printer complex system as claimed in claim 52, wherein the plurality of printer units are arranged in the main scan direction within a range substantially equal to a total of array ranges of the print elements of the print heads of all the printer units, and the plurality of printer units are supported by the support member so as to extend also in a subscan direction which is a print medium transport direction, and the print timing signal includes a print start signal independently supplied to each of the plurality of printer units according to a position in the subscan direction and a print medium position signal commonly supplied to enable the plurality of printer units to execute a printing operation according to a position of the print medium being transported.

54. A printer complex system as claimed in claim 52, wherein the same number of print heads corresponding to the number of colors are arranged side by side in a direction perpendicular to the predetermined direction in each of the plurality of printer units.

55. A printer complex system as claimed in claim 54, wherein the order of side-by-side arrangement corresponding to the colors in the same among all the printer units.

56. A printer complex system as claimed in claim 52, wherein each of the plurality of printer units uses a print head having ink ejection nozzles as the print elements.

57. A printer complex system as claimed in claim 52, further comprising means for distributing ink in each of the plurality of printer units, wherein each of the plurality of printer units has means for supplying an amount of ink corresponding to the print data to the print head.

58. A printer complex system as claimed in claim 57, wherein each of the plurality of printer units has a tank containing ink distributed from the distribution means and means for bringing the tank into or out of ink communication with the distribution means according to the accommodated ink volume in the tank.

59. A printer complex system as claimed in claim 58, wherein each of the plurality of printer units has means for performing a recovery operation by discharging ink from the print head to maintain an ink ejection performance of the print head in good condition, and means for circulating, to the tank, the discharged ink from the print head in the recovery operation.

60. A printer complex system as claimed in claim 52, wherein each printer unit holds a print head having print elements arrayed therein in a predetermined direction within a predetermined range and can be mounted on the support member.

61. A printer complex system as claimed in claim 52, wherein each printer unit includes:
a tank containing ink distributed from distribution means; and
means for bringing the tank into or out of ink communication with the distribution means according to the accommodated ink volume in the tank.

62. A printer complex system as claimed in claim 61, wherein each printer unit includes:
means for performing a recovery operation by discharging ink from the print head to maintain an ink ejection performance of the print head in good condition, and
means for circulating, to the tank, the discharged ink from the print head in the recovery operation.

63. A printer complex system as claimed in claim 60, wherein each print head is mountable on the printer unit.

64. A printer unit for printing data supplied from an information processing device to be printed on a print medium transported by a transport device, the printer unit comprising:
means for receiving the print data;
means for holding the received print data in a bitmap format;
means for receiving a print timing signal supplied in synchronism with the transport of the print medium by the transport device; and
means for executing a printing operation of the print data held in the holding means in response to the print timing signal.
